(19) United States
(12) Patent Application Publication
(10) Pub. No.: US 2016/0042152 A1
(43) Pub. Date: Feb. 11, 2016

(54) Dynamic Presentation of Goals and Therapies Including Related Devices and Applications

(71) Applicant: Orb Health, Inc., Phoenix, AZ (US)

(72) Inventor: Paul Oran, Phoenix, AZ (US)

(21) Appl. No.: 14/480,443

(22) Filed: Sep. 8, 2014

Related U.S. Application Data
(60) Provisional application No. 62/033,483, filed on Aug. 5, 2014.

(51) Int. Cl. G06F 19/00

(52) U.S. Cl. CPC G06F 19/3475; G06F 19/3431; G06F 19/3418; G06F 19/3406

(57) ABSTRACT

The disclosure herein relates generally relate, for example, to the dynamic identification of health goals (such as health therapies, plans, and guidance, among other examples) and related devices and/or computing applications. Methods and systems for automatically determining and causing the display of such health goals, devices and computing applications are disclosed.

### CROSS REFERENCE

This application claims priority to U.S. Provisional Patent Application Ser. No. 62/033,483 filed Aug. 5, 2014, which is incorporated by reference herein in its entirety.

### COPYRIGHT NOTICE

Contained herein is material that is subject to copyright protection. The copyright owner has no objection to the reproduction of the patent disclosure by any person as it appears in the Patent and Trademark Office patent files or records, but otherwise reserves all rights to the copyright whatsoever.

### BACKGROUND

The recent proliferation of computing technologies has made it possible to collect, analyze, and present many different types of information for the benefit of users of such computing technologies. Moreover, computing technologies have become prevalent in a number of health-related technologies. For instance, computing technologies are increasingly used by patients, consumers, care providers, doctors, hospitals, retail health clinics, physician networks, and accountable care organizations, among other such individuals and entities, to analyze, review, and otherwise use health information.

### SUMMARY

There is a need for systems and methods that provide for convenient and efficient determination and recommendation of health goals, including health therapies, plans, and/or strategies, among other examples. Moreover, there is a need for systems and methods that provide for convenient and efficient determination and recommendation of devices and/or computing applications associated with such health goals. Disclosed herein are such systems and methods.

In one aspect, a first method involves: (a) detecting, by a computing system, an identification of at least one health goal; (b) selecting, by the computing system, one or more of (i) at least one device or (ii) at least one application based on the detected identification of the at least one health goal; and (c) causing, by the computing system, a graphical display to display an indication of the selected one or more of (i) at least one device or (ii) at least one application.

In another aspect, a first non-transitory computer readable medium having instructions stored thereon is disclosed. The instructions include: (a) instructions for detecting, by a computing system, an identification of at least one health goal; (b) instructions for selecting, by the computing system, one or more of (i) at least one device or (ii) at least one application based on the detected identification of the at least one health goal; and (c) instructions for causing, by the computing system, the graphical display to display an indication of the selected one or more of (i) at least one device or (ii) at least one application.

In another aspect, a first system that includes a processor, a non-transitory computer readable medium, and program instructions stored on the non-transitory computer readable medium is disclosed. The program instructions are executable by the processor to: (a) detect, by a computing system, an identification of at least one health goal; (b) select, by the computing system, one or more of (i) at least one device or (ii) at least one application based on the detected identification of the at least one health goal; and (c) cause, by the computing system, the graphical display to display an indication of the selected one or more of (i) at least one device or (ii) at least one application.

In another aspect, a second method involves: (a) receiving, by a computing system, an identification of a given patient from among a plurality of patients; (b) receiving, by the computing system, an identification of at least one health goal corresponding to the given patient; (c) selecting, by the computing system, one or more of (i) at least one device or (ii) at least one application based on the received identification of the at least one health goal; (d) causing, by the computing system, the graphical display to display an indication of the selected one or more of (i) at least one device or (ii) at least one application; and (e) detecting, by the computing system, an identification of at least one of the selected one or more of (i) at least one device or (ii) at least one application.

In another aspect, a second non-transitory computer readable medium having instructions stored thereon is disclosed. The instructions include: (a) instructions for receiving, by a computing system, an identification of a given patient from among a plurality of patients; (b) instructions for receiving, by the computing system, an identification of at least one health goal corresponding to the given patient; (c) instructions for selecting, by the computing system, one or more of (i) at least one device or (ii) at least one application based on the received identification of the at least one health goal; (d) instructions for causing, by the computing system, the graphical display to display an indication of the selected one or more of (i) at least one device or (h) at least one application; and (e) instructions for detecting, by the computing system, an identification of at least one of the selected one or more of (i) at least one device or (ii) at least one application.

In another aspect, a second system that includes a processor, a non-transitory computer readable medium, and program instructions stored on the non-transitory computer readable medium is disclosed. The program instructions are executable by the processor to: (a) receive, by a computing system, an identification of a given patient from among a plurality of patients; (b) receive, by the computing system, an identification of at least one health goal corresponding to the given patient; (c) select, by the computing system, one or more of (i) at least one device or (ii) at least one application based on the received identification of the at least one health goal; (d) cause, by the computing system, the graphical display to display an indication of the selected one or more of (i) at least one device or (ii) at least one application; and (e) detect, by the computing system, an identification of at least one of the selected one or more of (i) at least one device or (ii) at least one application.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1A shows a simplified block diagram of aspects of an example network.

FIG. 1B shows a simplified block diagram of additional aspects of the example network.

FIG. 1C shows a simplified block diagram of additional aspects of the example network.

FIG. 2 shows a simplified block diagram of an example network access device.

FIG. 3 shows a simplified block diagram of an example server.

FIG. 4 shows a flowchart of a first example method.

FIGS. 5A-5G show aspects of an example user interface.

FIG. 6 shows a flowchart of a second example method.

FIGS. 7A-7E show aspects of an example user interface.

FIGS. 8A-8B show aspects of an example user interface.

### DETAILED DESCRIPTION

In the following detailed description, reference is made to the accompanying figures, which form a part thereof in the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that aspects of the present disclosure, as generally described herein, and illustrated in the figures, can be arranged, substituted, combined, separated, and/or designed in a wide variety of different configurations, all of which are contemplated herein.

### 1. EXAMPLE ARCHITECTURE

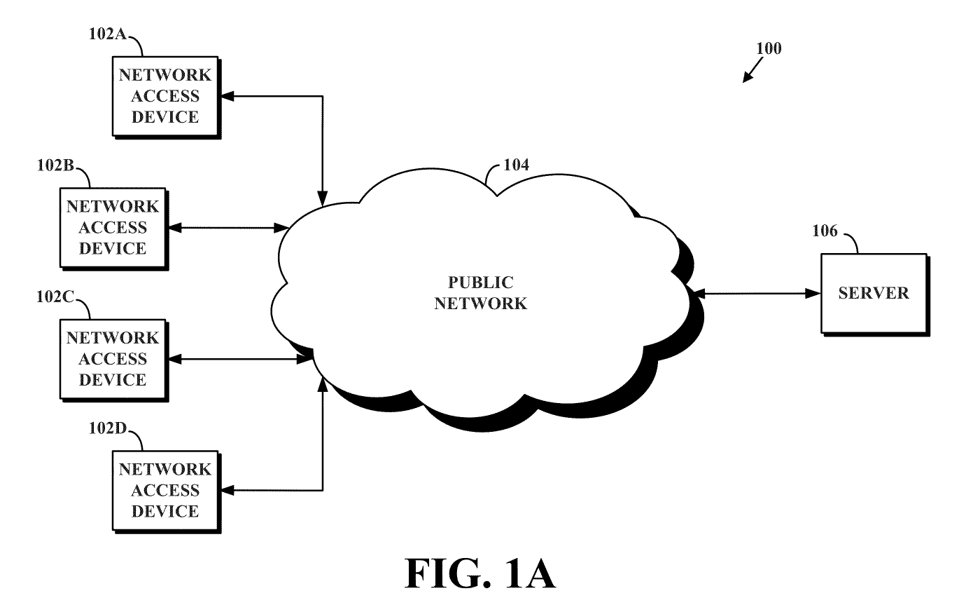

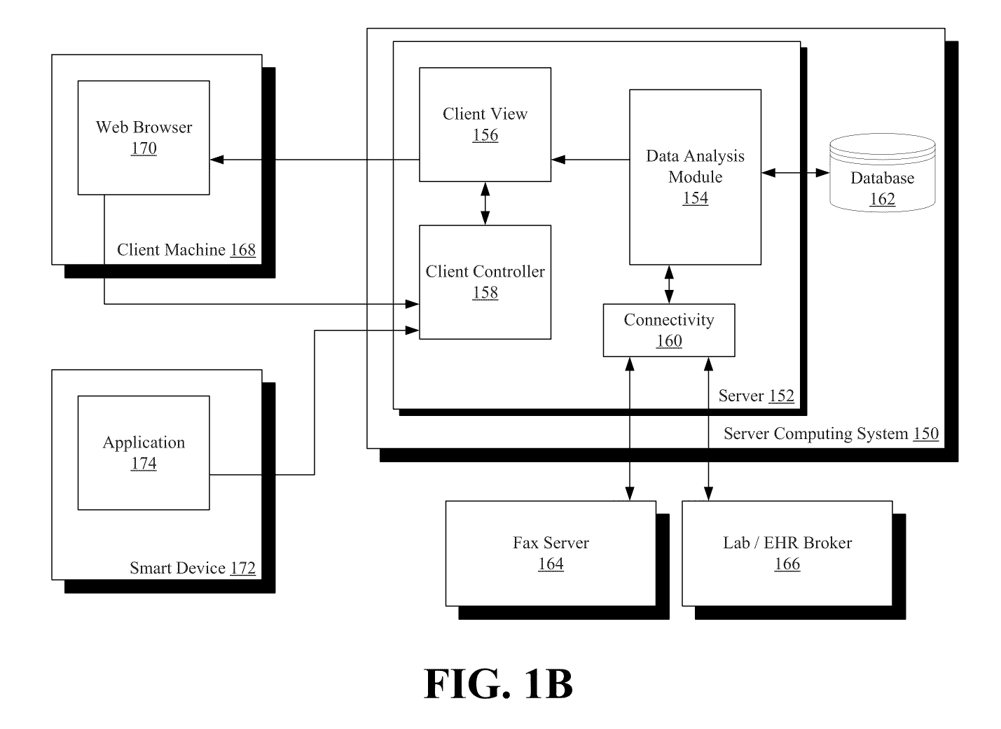

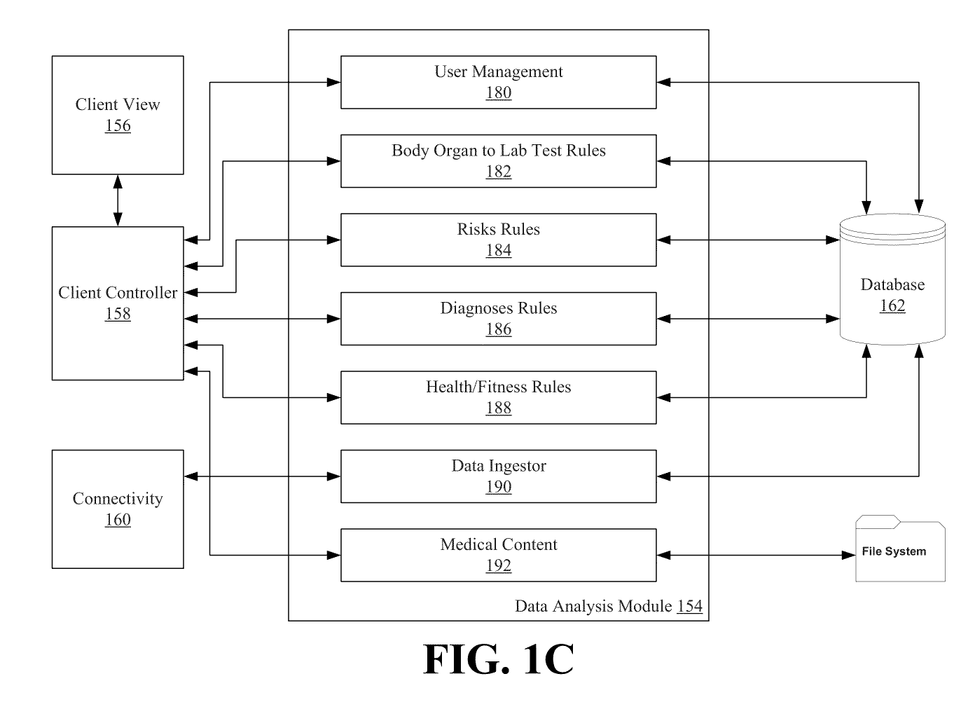

FIG. 1A shows a simplified block diagram of an example communication network in which the present method can be implemented. It should be understood that this and other arrangements described herein are set forth only as examples. Those skilled in the art will appreciate that other arrangements and elements (e.g., machines, interfaces, functions, orders, and groupings of functions, etc.) can be used instead and that some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. And various functions described herein may be carried out by a processor executing instructions stored in memory.

As shown in FIG. 1A, example network 100 includes various network-access devices 102A-102D, public network 104 such as the Internet, and server 106. Note that additional entities not depicted in FIG. 1A could be present as well. As an example, there could be more network-access devices and more servers in communication with public network 104. Other network elements may be in communication with public network 104 as well. Also, there could be one or more devices and/or networks making up at least part of one or more of the communication links depicted in FIG. 1A. As an example, there could be one or more routers, switches, or other devices or networks on the communication links between network-access devices 102A-102D, public network 104, and/or server 106.

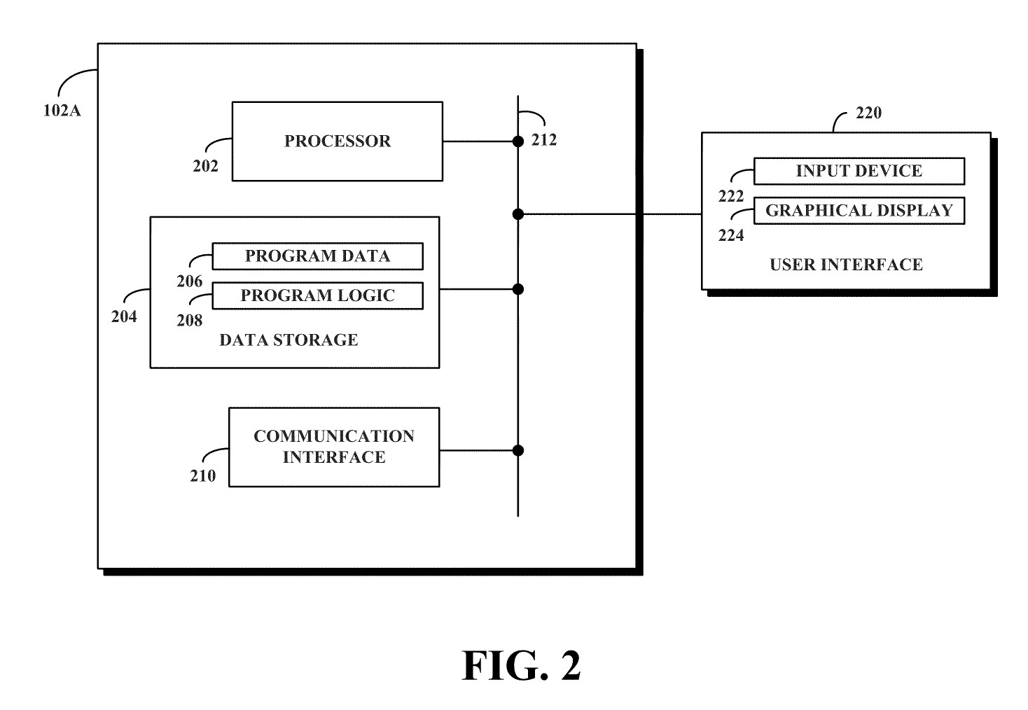

Each of network-access devices 102A-102D may be any network-access device arranged to carry out the network-access device functions described herein. Generally, the network-access device may be any suitable computing device, such as a computer, laptop computer, tablet computer, and/or smartphone, among other examples. The operation of the network-access device may be effected by software or firmware code stored in a non-volatile data store and executed via a general purpose processor transformed by the software or firmware code into a specific purpose processor, or may be effected solely by a hardware structure, or a combination of the two. As such each of network-access devices 102A-102D, including network-access device 102A as shown in FIG. 2, may include processor 202, data storage 204, and communication interface 210, all linked together via system bus, network, or other connection mechanism 212.

Processor 202 may comprise one or more general purpose microprocessors and/or one or more dedicated signal processors and may be integrated in whole or in part with communication interface 210. Data storage 204 may comprise memory and/or other storage components, such as optical, magnetic, organic or other memory disc storage, which can be volatile and/or non-volatile, internal and/or external, and integrated in whole or in part with processor 202. Data storage 204 may be arranged to contain (i) program data 206 and (ii) program logic 208. Although these components are described herein as separate data storage elements, the elements could just as well be physically integrated together or distributed in various other ways. For example, program data 206 may be maintained in data storage 204 separate from program logic 208, for easy updating and reference by program logic 208.

Communication interface 210 typically functions to communicatively couple network-access device 102A to networks, such as public network 104. As such, communication interface 210 may include a wired (e.g., Ethernet) and/or wireless (e.g., Wi-Fi) packet-data interface, for communicating with other devices, entities, and/or networks. Network-access device 102A may also include multiple interfaces 210, such as one through which network access device 102A sends communication, and one through which network-access device 102A receives communication.

Network-access device 102A may also include, or may be otherwise communicatively coupled to, user interface 220. User interface 220 may include input device 222 comprising, for example, buttons, a touch screen, a microphone, and/or any other elements for receiving inputs. User interface 220 may also include one or more elements for communicating outputs, for example, one or more graphical displays 224 and/or a speaker. In operation, user interface 220 may be configured to display a graphical user interface (GUI) via graphical display 224 and may also be configured to receive inputs, via input device 222, corresponding to use of such a GUI.

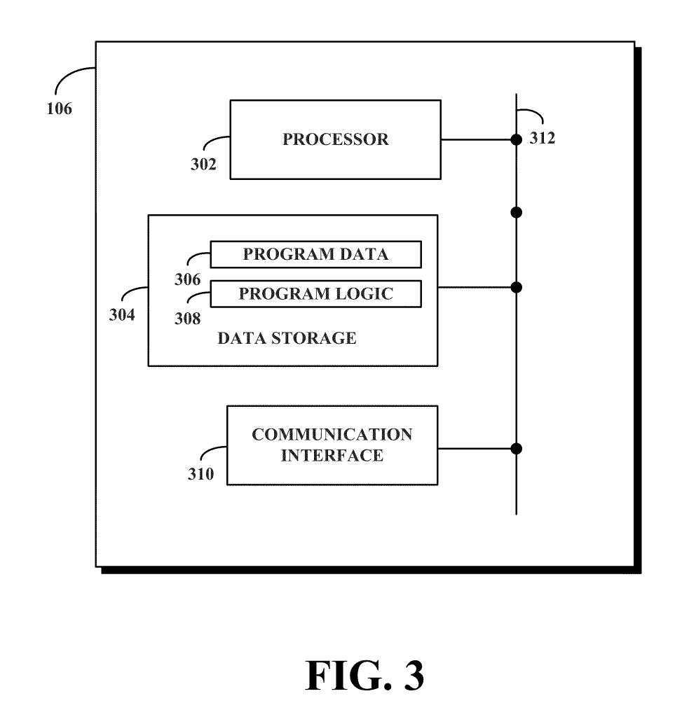

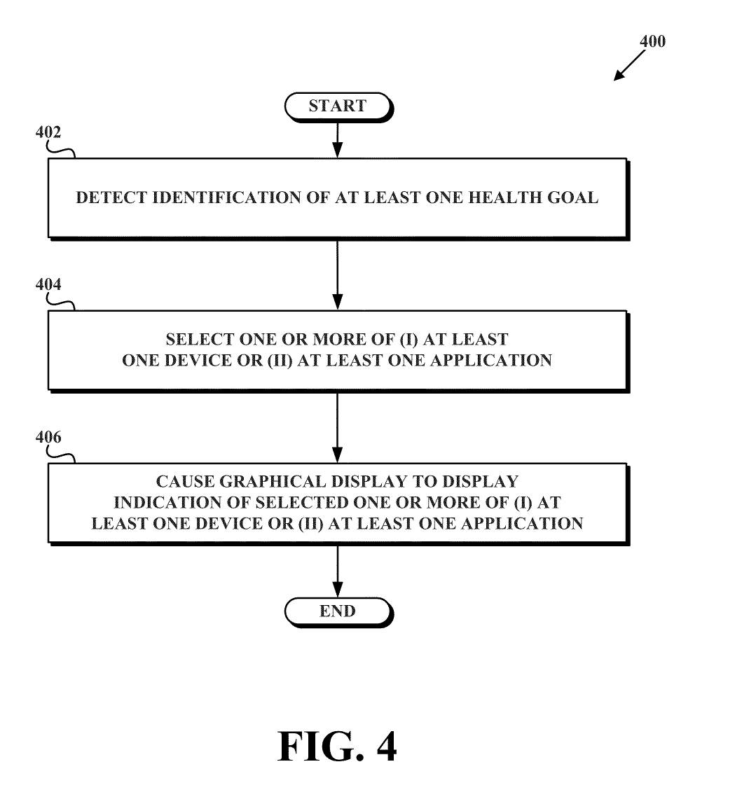

Server 106 may be any network server or other computing system arranged to carry out the server functions described herein including, but not limited to, those functions described with respect to FIG. 4. As such, as shown in FIG. 3, server 106 may include processor 302, data storage 304 comprising program data 306 and program logic 308, and communication interface 310, all linked together via system bus, network, or other connection mechanism 312. Processor 302, data storage 304, program data 306, program logic 308, and communication interface 310 may be configured and/or arranged similar to processor 202, data storage 204, program data 206, program logic 208, and communication interface 210, respectively, as described above with respect to network-access device 102A.

Data storage 304 may contain information used by server 106 in operation. For example, date storage 304 may comprise instructions executable by the processor for carrying out the server functions described herein including, but not limited to, those functions described below with respect to FIG. 4. As another example, data storage 304 may contain various design logic and/or design data used for determining a test result, such as the logic and data described below with respect to FIG. 4. Generally, data storage 304 may contain information used by server 106 to provide a graphical user interface that is accessible by various network-access devices, such as network-access device 102A, over public network 104.

Returning to FIG. 1A, public network 104 may include one or more wide area networks, one or more local area networks, one or more public networks such as the Internet, one or more private networks, one or more wired networks, one or more wireless networks, and/or one or more networks of any other variety. Devices in communication with public network 104 (including, but not limited to, network-access devices 102A-102D and server 106) may exchange data using a packet-switched protocol such as IP, and may be identified by an address such as an IP address.

FIG. 1B shows additional and/or alternative aspects of example network 100 described with respect to FIG. 1A. As shown in FIG. 1B, two example network access devices are shown: smart device 172 and client machine 168. Smart device 172 is shown as including application 174, which smart device 172 may use to access server computing system 150. Client machine 168 is shown as including web browser 170, which client machine 168 may use to access server computing system 150.

Server computing system 150, and/or aspects thereof, is an example of server 106, and/or aspects thereof. As shown, server computing system 150 includes server 152. Server 152 may include various components, each of which may be implemented in hardware, software, and/or a combination therefore. For instance, server 152 may include data analysis module 154, which may generally interface with database 162 (discussed further below) and analyze data according to various rules and/or program code. Data analysis module 154 may be coupled to client view 156 and/or client controller 158, which may serve to enable server 152 to interface with remote devices such as client machine 168 and smart device 172. Data analysis module 160 may also be coupled to connectivity component 160, which enables server 152 to communicate with any desired remote information and/or data source such as fax server 164 and/or Lab/electronic health record (EHR) systems or hubs 166. Examples of Lab/EHR systems or hubs 166 include, but are not limited to, lab networks (Quest Diagnostics, LabCorp, Solstace) and EMR systems (Prime Clinical Systems, PointClickCare, Health Systems, INConcertCAre, Vivature, Medcomsoft, ICANotes, Prowess, SigmundSoftware, Claimpower, Optimantra, Abel Medial Software, Allscripts, AmazingCharts, AthenaHealth, Cerner, and eClinicalWorks). In some implementations, Lab/HER systems or hubs 166 may communicate with server 152 using Health Level-7 (HL7) message standards/protocols.

Server 152 may be communicatively coupled to database 162. Server 152 may maintain database 162 locally. For instance, server 152 may maintain database 162 within data storage of server 152 and/or within external data storage that is directly connected to server 152. Additionally and/or alternatively, server 152 may maintain database 162 remotely. For instance, server 152 may maintain database 162 at one or more remote computing devices and/or storage devices that server 152 may access using one or more network connections.

FIG. 1C shows additional and/or alternative aspects of example network 100 described above with respect to FIGS. 1A and 1B. More particularly, FIG. 1C shows further aspects of server computing system 152. As shown, data analysis module 154 may include various analysis modules each of which may interface with other aspects of server computing system 152, including database 162.

Data analysis module 152 may include user management module 180, body organ to lab test rules module 182, risk rules module 184, diagnoses rules module 186, health/fitness rules module 188, data ingestor module 190, and medical content module 192. Other examples of such modules may exist. As shown, various of modules 180-192 may communicate with and/or otherwise interface with any of client view component 156, client controller component 158, connectivity component 160, database 162, and/or any other suitable component such as one or more other file systems. The various modules 180-192 may be implemented in software, hardware, and/or a combination thereof. Certain of modules 180-192 are discussed further below.

### 2. FIRST EXAMPLE METHOD

FIG. 4 shows a flowchart depicting an example method for dynamically selecting and displaying devices and/or applications. Method 400 is described, by way of example, as being carried out by a computing system such as, for example, server 106. However, it should be understood that example methods disclosed herein, such as method 400, may be carried out by computing systems other than a server, and/or may be carried out by sub-systems in a server or in other devices. For example, the example method may alternatively be carried out entirely by a network-access device or some other computing system that may or may not be coupled to any network. Other examples are also possible.

Furthermore, those skilled in the art will understand that the flowchart described herein with respect to FIG. 4 illustrates functionality and operation of certain implementations of example embodiments. In this regard, each block of the flowchart may represent a module, a segment, or a portion of program code, which includes one or more instructions executable by a processor (e.g., processor 302 described below with respect to server 106) for implementing specific logical functions or steps in the process. The program code may be stored on any type of computer readable medium (e.g., computer readable storage medium or non-transitory media, such as data storage 304 described above with respect to server 106), for example, such as a storage device including a disk or hard drive. In addition, each block may represent circuitry that is wired to perform the specific logical functions in the process. Alternative implementations are included within the scope of the example embodiments of the present application in which functions may be executed out of order from that shown or discussed, including substantially concurrent or in reverse order, depending on the functionality involved, as would be understood by those reasonably skilled in the art.

FIG. 4 shows a flowchart depicting functions that can be carried out in accordance with at least one embodiment of the method. As shown in FIG. 4 method 400 begins at block 402 with server 106 detecting (perhaps by way of public network 104), an identification of at least one health goal. At block 404, server 106 selects one or more of (i) least one device or (ii) at least one application based on the detected identification of the at least one theory. At block 406, server 106 causes, via user interface 220 of network-access device 102A (perhaps by way of public network 104), a graphical display to display an indication of the selected one or more of (a) at least one device or (b) at least one application. These steps are explained further in the following subsections.

a. Detect Identification of Health Goal

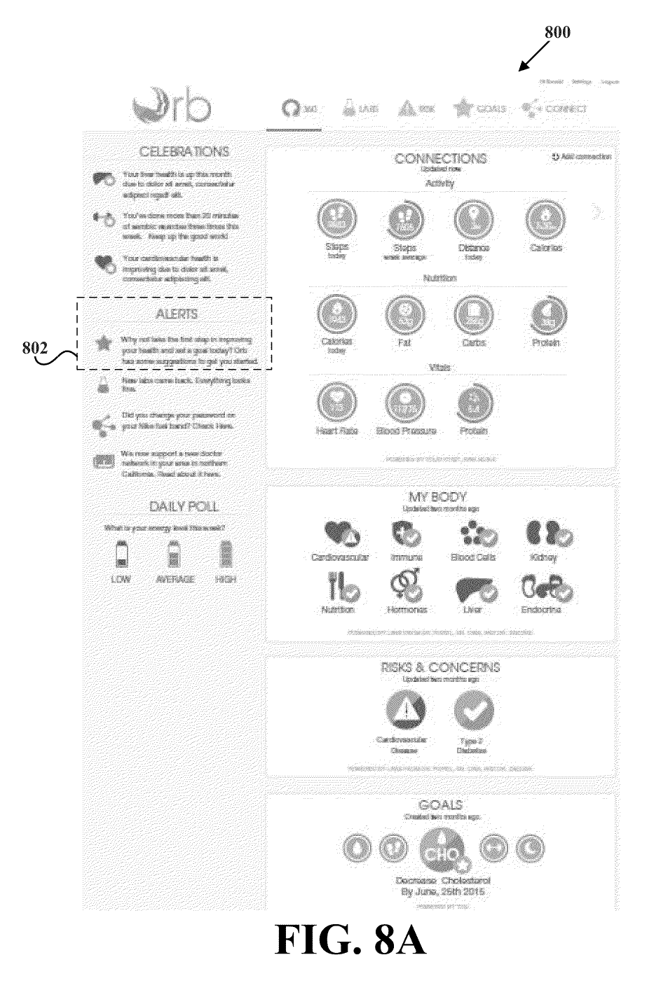

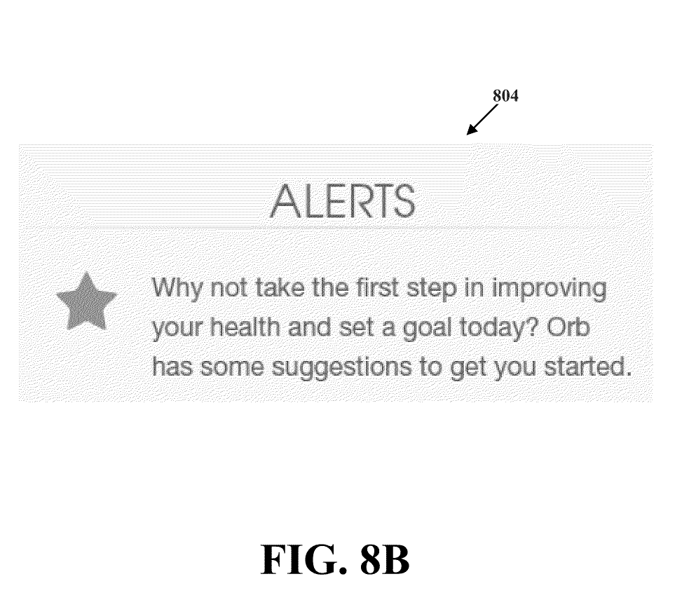

At block 402, server 106 detects (perhaps by way of public network 104), an identification of at least one health goal. As discussed further below, the identified health goal may correspond to at least one health condition that has been identified as being associated with a patient. Such a health condition may be one or more of a diagnosis, risk factor, and/or other indication of a potential health concern. The user may be presented with a notification that from their most recent lab work, one or more suggested goals are available for their review. For instance, as shown in FIG. 8A, example user interface 800 includes alerts element 802 that prompts a user to set a goal by suggesting “Why not take the first step in improving your health and set a goal today? Orb has some suggestions to get you started.” FIG. 8B shows an alternative view 804 of alerts element 802. Other examples of such an alert exist. Alternatively, the user may visit a goals component of the application to review such goals.

As also discussed further below, in one implementation, the user may be notified via an email or mobile notification that a specific lab result, health condition, diagnoses, health risk requires their attention. Such a prompt will provide the user the option to identify a health goal—i.e., set a goal to improve the condition, identify potential treatments, and/or perform other functions. The health goal may be associated with one or more therapies that a patient may pursue to help obtain the health goal. As a general matter, suggested therapies may include an identification of health applications and/or wearable devices that may assist and/or otherwise benefit a patient in pursuing an identified health goal.

The at least one health goal may be associated with any suitable physical and/or health therapy. Examples of such health goals include, among other examples: improve a lab test result (e.g., reduce cholesterol to a predetermined cholesterol level); reduce weight to a predetermined weight; decrease risk for a health condition or disease (e.g., cardiovascular disease, diabetes, kidney disease, liver disease, etc.); successfully manage a preexisting health condition (e.g., type 2 diabetes); and/or treat and/or reverse a new health condition or diagnoses (e.g., pre-diabetes). Other examples of such health goals exist.

In another instance, the health goal may be a fitness goal. Examples of such fitness goals include, among other examples: perform a given number of body-weight exercise movements (e.g., push ups); perform a given number of other exercise movements (e.g., a bench press at a predetermined weight); run a predetermined distance; run a predetermined distance in a predetermined amount of time; and/or perform certain kinds of physical activity over longitudinal time frame (e.g., 30 minutes of intense exercise for 3 out 7 days in a week). Other examples of such fitness goals exist.

In another instance, the health goal may be a health and/or fitness plan. Examples of such health and/or fitness plans include, among other examples: run a predetermined number of miles per day; eat a predetermined number of calories per day; a wellness weight loss plan (e.g., to help treat diabetes); and/or a nutrition plan or program (e.g., to help treat diabetes). Health or fitness plans may include a set of encouragement notifications (via email, text, mobile notifications, online alerts, etc.) to remind and motivate the user to complete their goal. Other examples of such health and/or fitness plans exist.

A given health and/or fitness plan may be dynamic in a number of respects. For instance, the plan may dynamically change over time based on a patient's progress. As one example, the frequency of an activity may be increased based on a patient's progress. As another example, the intensity of an activity may be increased based on a patient's progress. As a given health and/or fitness plan dynamically changed, server 106 may cause a graphical display to provide an indication of the changed health and/or fitness plan.

In another instance, the health goal includes a therapy that includes a medication recommendation and/or prescription. Examples of such a medical recommendation and/or prescription include, among other examples: recommended supplements, over the counter drugs, or prescription drugs for a specific health condition. Other examples of such medication recommendations and/or prescriptions exist. A physician may be required to approve and write a prescription for such treatments.

As a general matter, a given health goal may be associated with one or more therapy groupings which support completion of the specific goal (e.g. improve cholesterol) and are directly related to the associated applications and devices that support completing the goal as presented by the system. Such therapy groupings may generally indicate categories of types or forms of data generated from associated applications and devices that support the completion of the health goal. Examples of such therapy groupings include, among other examples: activity (sub data types include: distance, calories burned, duration of activity, steps, stairs, etc), nutrition (sub data types include: calories consumed, carbohydrates, fat, fiber, protein, water, etc.) sleep (sub data types include: time awake, time deep sleep, REM cycles, times woken, etc.), weight (sub data types include: weight, free mass, percent fat, body mass index), diabetes (sub data types include: glucose tracking e.g. glucometer, hba1c, insulin, etc.), biometrics (sub data types include: resting heart rate, diastolic, systolic, peripheral capillary oxygen saturation, etc.). Other examples of such therapy groupings exist. Therapy groupings can be enabled by linking the user account to a third party device or application.

As a general matter, a given health goal may also be associated with a completion and/or finish date. For instance, a health and/or fitness goal may specify that the health and/or fitness goal should be completed by a predetermined date in the future. Similarly, a health and/or fitness plan may specify that the health and/or fitness plan should be followed until a predetermined date in the future.

The identification of the at least one health goal may be received by server 106 via a direct and/or indirect communication link with a computing system, server, or other network entity at which the at least one health goal is identified. In this way, server 106 may receive the identified at least one health goal from a computing system associated with a health-service provider including, among other examples, a computing system associated with a physician. As one specific example, server 106 may receive an identified at least one health goal generated by, and made accessible by, a physician (or other such health care and/or service provider) by way of an application program interface (API) provided by a physician, health care and/or service provider, or an associated entity.

Alternatively, the identified at least one health goal may be received by server 106 as a result of manual user input. For instance, server 106 may cause network-access device 102A to provide a prompt, form, or other data-input interface for a user to identify (via, for example, an input) at least one health goal. For instance, a user of network-access device 102A may provide a user input that identifies the at least one health goal, and may then submit the identified at least one health goal to server 106. Other examples may exist as well.

Accordingly, before detecting the identification of the at least one health goal, server 106 may cause a graphical display (such as graphical display 224 of network-access device 102A) to display an indication of a plurality of health goals. A user may then identify (perhaps via user input) one of the displayed indication of a plurality of health goals.

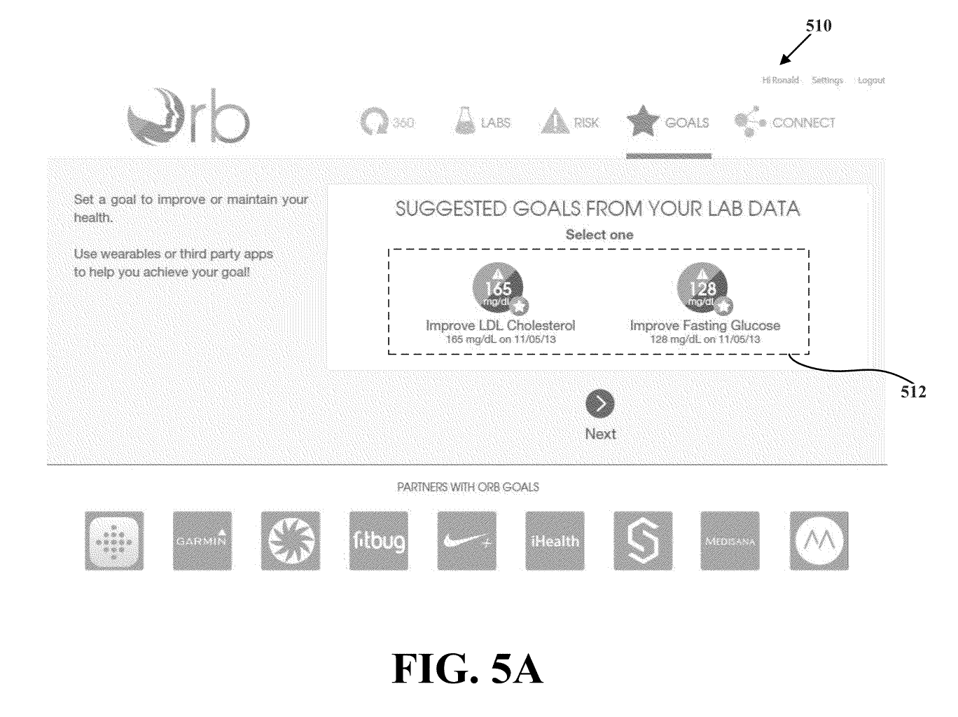

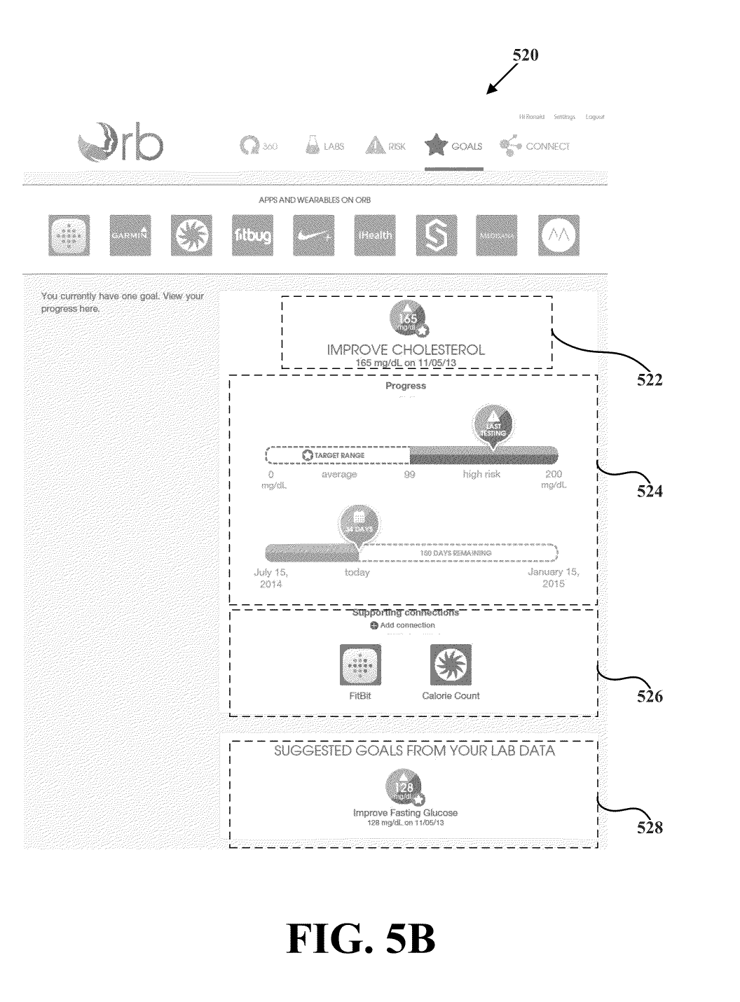

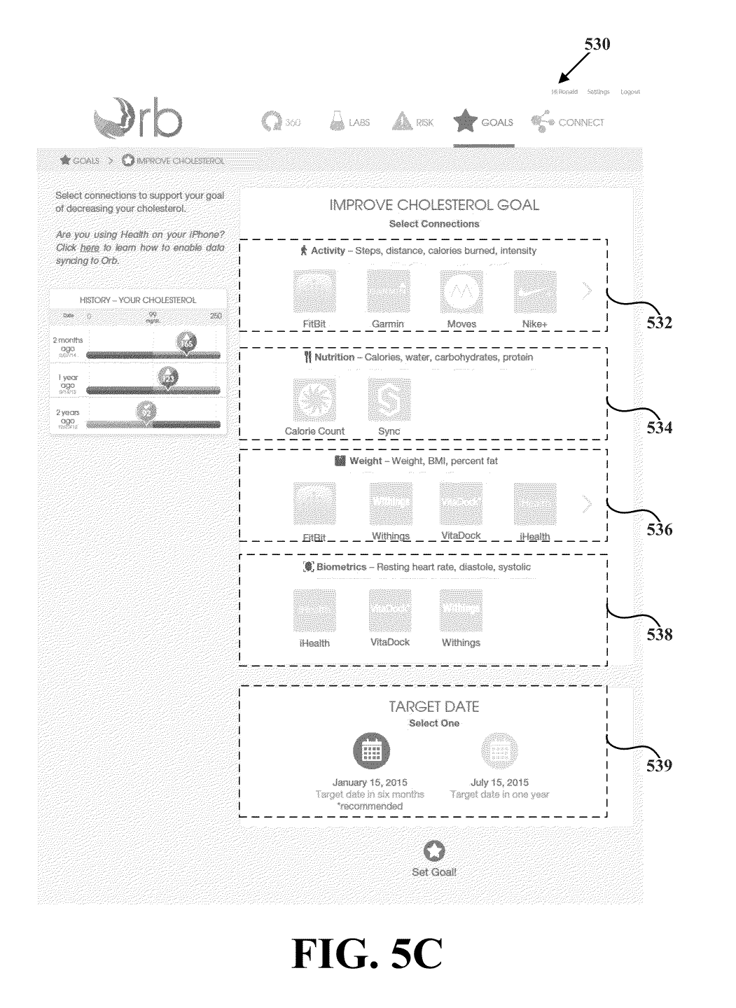

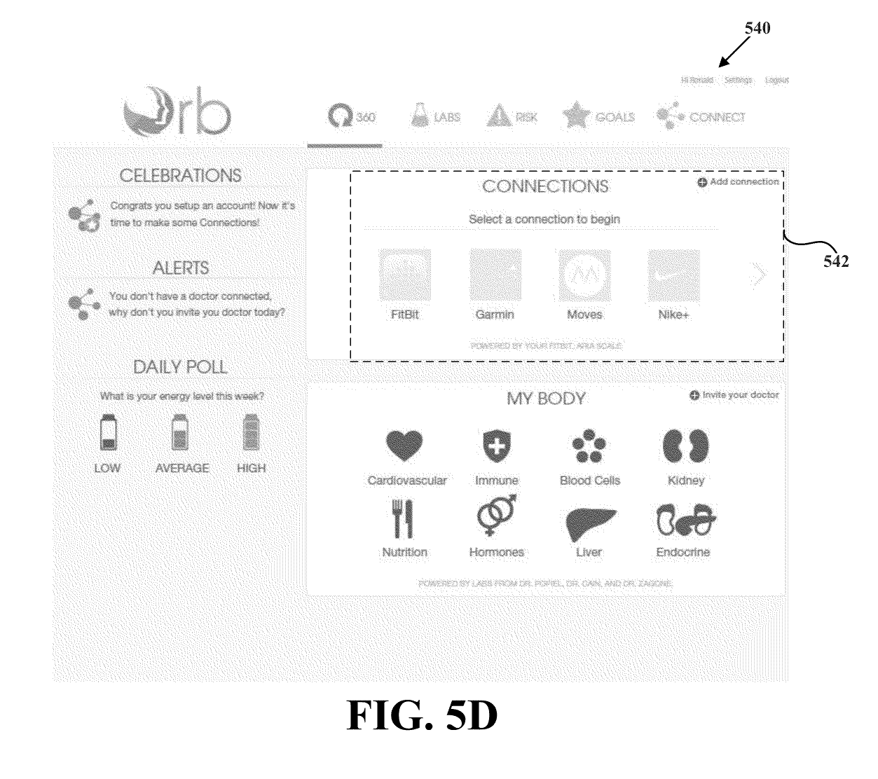

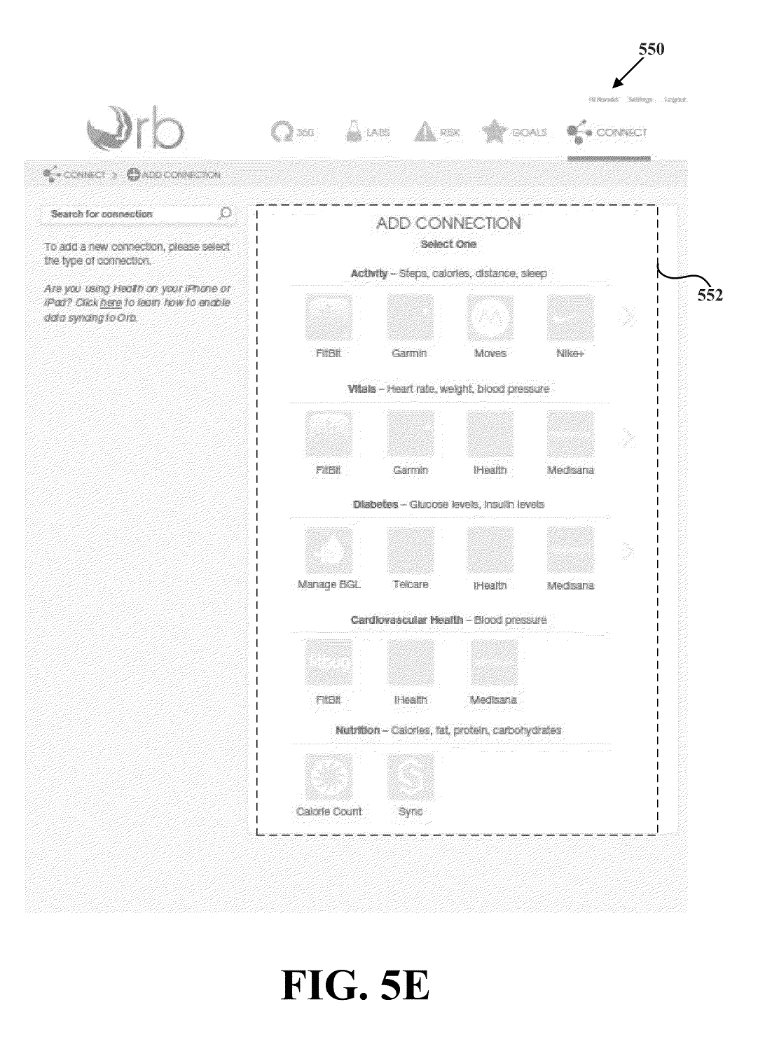

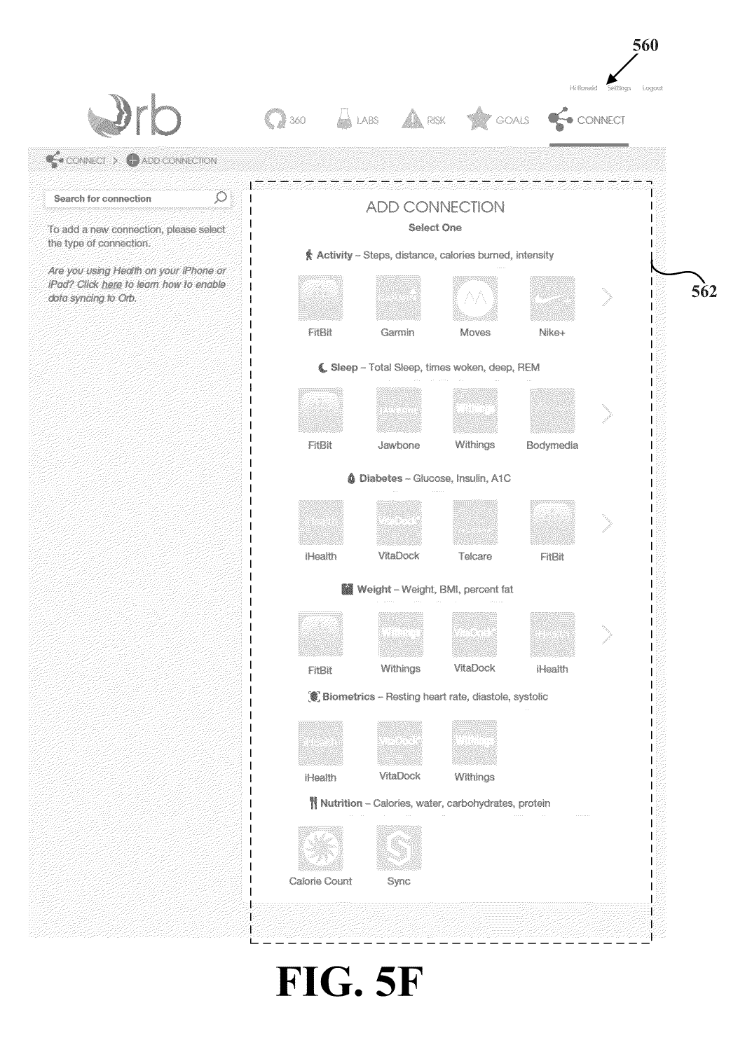

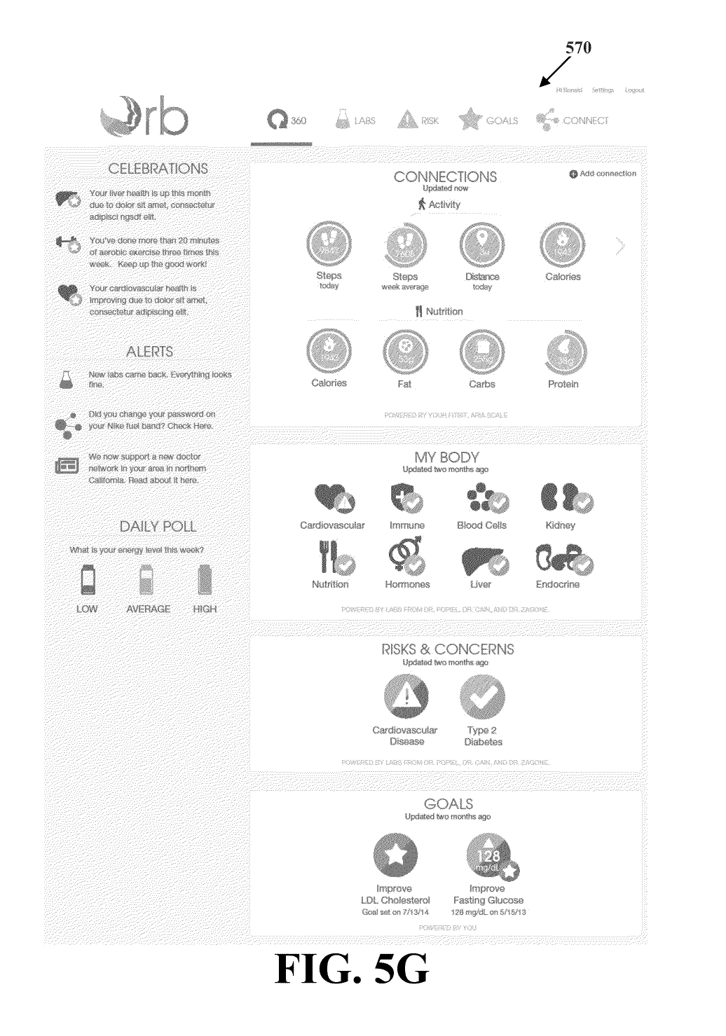

As one example, FIG. 5A shows an example user interface 510 in accordance with method 400. FIG. 5A shows an example display of a plurality of health goals 512. Health goals 512 may be understood to have been identified by server 106 based on health data.

As shown, health goals 512 include “Improve LDL Cholesterol” and “Improve Fasting Glucose. Other such examples exist. As will be discussed further, either such example health goal may be selected by a patient for further review and/or for instantiation as a health goal that the patient desires to pursue.

Before causing the graphical display to display the indication of the plurality of health goals, server 106 may determine the plurality of health goals based on the health data. The health data may be maintained locally by server 106 and/or remotely to server 106.

Maintaining the health data may involve server 106 receiving the health data via at least one of (i) a network interface or (ii) a user interface. For instance, the health data may be received via the network interface, over a Wide Area Network (WAN), from another computing system associated with a health service provider, among other examples. Additionally and/or alternatively, the health data may be received via the user interface, such as by receiving the health data as a result of detecting a touch input (or other manual input) by a patient at the user interface. In such instances, the health data may then be received by server 106 via a WAN. In some instances, the health data may be received via both the network interface and the user interface.

As a general matter, the health data may take any desired form. Generally, the health data may include laboratory-test information reflecting information concerning a laboratory test taken, executed, or otherwise performed by the patient on a given test date. For instance the laboratory-test information may include the results of an assortment of dozens or even thousands of uncategorized labs performed (genomics testing, in-vitro diagnostic testing) or even a single lab test (e.g. Glucose), the result from the lab test(s) which may contain qualitative or quantitative information (e.g. 85), the normal range or normal qualitative state of a healthy sample (e.g. 65-99), and/or the units for the specific lab test (e.g. mg/dL). The laboratory-test information may include other information such as the patient's address, the ordering physician, patient-demographic information, policy information, and/or any patient-risk information provided by the laboratory. Other examples of laboratory-test information may exist as well.

The health data may be received by server 106 via a direct and/or indirect communication link with a computing system, server, or other network entity associated with a laboratory that performs the laboratory test. In this way, server 106 may receive health data such as laboratory-test information from the laboratory that performs the laboratory test. As one specific example, server 106 may access laboratory-test information generated by, and made accessible by, a laboratory by way of an application program interface (API) provided by the laboratory or an associated entity. Server 106 may receive such laboratory-test information via an API as test data.

Alternatively, the health data may be received by server 106 as a result of manual user input. For instance, server 106 may cause network-access device 102A to provide a prompt, form, or other data-input interface for a user to input health data including laboratory-test information generated by and received from the laboratory that performs the laboratory test. For instance, a user of network-access device 102A may receive laboratory-test information for the laboratory in paper form (or another form), and may then submit some or all of such laboratory-test information to server 106 as test data. Other examples of health data may exist as well.

As another alternative, the health data may also include patient-submitted information containing subjective and/or objective information experienced, determined, or otherwise acquired by the user. For instance, server 106 may cause network-access device 102A to provide a prompt, form, or other data-input interface for a user to input patient-submitted information. Examples of subjective patient-submitted information may include the user's mood, whether the patient is “tired,” and/or whether the patient is feeling “well.” Examples of objective patient-submitted information may include the user's weight, what the user ate at a given time, and/or an amount of sleep the patient experienced on a given day. Other examples of subjective and/or objective patient-submitted information may exist as well.

The health data may additionally or alternatively include analysis-type data indicating an analysis type and patient-history data indicating a particular patient-test date. Such data may be input by a user in any suitable manner. In an embodiment, server 106 may cause network-access device 102A to display a question, series of questions, a data-entry field, or a selectable button, among other possible examples, that prompt or otherwise allow the user to specify certain analysis-type data and/or patient-history data. Accordingly, server 106 may store logic arranged to prompt the user in such a manner. The input provided in response to the prompt may be input by the user using input device 222, and the input may be received by server 106 in the form analysis-type data and/or patient-history data.

The analysis type indicated by the analysis-type data may take on any desired form. Generally, the analysis-type data may reflect a medical analysis that has been previously performed with respect to diagnostic-test information. For instance, the analysis type may include test results related to the following health conditions and/or lab test order types: cardiovascular, thyroid, diabetes, adrenals, sex hormone, cellular health, liver, cbc (complete blood count), cmp (comprehensive metabolic panel), lipids, cardiac, kidney, iron, autoimmune, clotting factors, female hormone, male hormone, cancer screening, bone health, urinalysis, and/or various genetics tests. Other examples of analysis types may exist as well.

The analysis type need not be limited to those commonly-recognized types, such as those described above. For example, the analysis type may incorporate tests that are a part of any one or more of the analysis types discussed above. Such an analysis type may be “standardized” and offered to a user consistently over time such that when the user engages in multiple analyses over time, the results will be comparable. In this way, the user may advantageously be able to observe changes across various laboratory-test information, over time.

The patient-test date indicated by the patient-history data may be one of a variety of dates corresponding to available laboratory-test information. Generally, the patient-test date may reflect a date that the patient submitted to a medical test and provided a medical sample (e.g., a blood test).

For purposes of example and explanation, in an implementation, the health data may be received by the computing system using a secure HL7 data stream. A parsing engine stored locally on, or remotely to, the computing system may take the health data (e.g., using a pearl implementation), sort the health data, and store the health data in a database (e.g. a database that is accessible via SQL statements or queries). More particularly, the health data may be sorted and stored into suitable tables. And the computing system may create new data or data sets based on the health data (e.g., using C++ and/or SQL query combination). And an extraction engine may include program code that is configured to extract data out of the database (e.g. using JASON, an intermediate coding language). The particular implementation, and aspects thereof described above is set forth only for purposes of example. The mentioned languages, computing systems, and components thereof should not be taken to be limiting. Those of skill in the art will appreciate that the present method may be implemented using a wide variety of programming techniques and/or computing systems.

Determining the plurality of health goals based on the maintained health data may be performed in any suitable manner. In one example, any one or more of the plurality of health goals may be determined based on an identification of a health risk or diagnoses from available health data such as test results.

The determination of the health goal may be performed using any suitable technique. Generally, the analysis-type data may reflect a medical analysis that has been previously performed with respect to laboratory-test information corresponding to a given patient-test date. For instance, the analysis type may be at least one of cardiovascular, thyroid, diabetes, adrenals, sex hormone, cellular health, Liver, CBC, CMP, Lipids, Cardiac, Kidney, Iron, Autoimmune, Clotting Factors, Female Hormone, Male Hormone, Cancer Screening, Bone Health, Urinalysis, and/or various genetics tests. Other examples of analysis types may exist as well. In this example, the following laboratory-test information may have caused a cardiovascular disease health risk notification: Cholesterol 220 mg/dL (which has a 100-199 mg/dL reference range), HDL cholesterol 33 mg/dL (which has a >39 mg/dL reference range) and LDL cholesterol 145 mg/dL (which has a 0-99 mg/dL reference range). Alternatively, glucose levels and Hemoglobin A1C levels could be used to indicate if one has diabetes or pre-diabetes. Many other examples exist across many health conditions. A health goal may be identified base on an identification of any such health condition and/or identification that a risk factor is out of range.

Alternatively, any one of a variety of known medical algorithms may be used. The term “medical algorithm” as used herein is meant to refer to any computation, formula, statistical survey, nomogram, or look-up table, useful in healthcare. Such medical algorithms may include decision tree approaches to healthcare treatment (i.e., if symptoms and/or lab test results A, B, and C are evident, then diagnosis X and therapy 1) and also other tools aimed at reducing or defining uncertainty. Other examples of medical algorithms used to determine health goals may exist as well.

In some implementations, server 106 may determine a health goal based on received health data, a set of health categories, and/or for each health category in the set of health categories, one or more respective health category metrics corresponding to the health category.

Health categories may be determined based on health data including, for example, in-vitro diagnostic testing, genetic testing, and/or other patient-submitted health data, among other examples. As noted above, examples of health data include laboratory test data. For purposes of example and explanation, health data may include individual lab test data (e.g., glucose or PSA), a series of uncategorized lab test data, or commonly used medical categories, yet still medically undefined/undiagnosed from collective data, including a complete blood count (WBC, RBC, Hemoglobin, Hematocrit, etc.) and lipid panel (cholesterol, triglyceride, HDL cholesterol, ldl cholesterol), among other examples. As discussed above, such health data may be provided to the system in any suitable manner (such as submission by a user via an interface).

For purposes of example and explanation, a health category may be, or may indicate, an individual's state of health, status or diagnosis of disease, a prognosis or risk assessment, or a therapeutic response to a drug, among other examples. Alternatively or additionally, health categories may include family history, health interests avid genetics, among other examples. Some specific non-limiting examples of health categories include the presence (or lack of presence) of diabetes (screening/diagnosis), cardiovascular disease (risk assessment), liver and kidney (e.g. health/disease assessment), and nutrition (health/disease assessment).

Additional example health categories corresponding to diagnostics include, but are not limited to: Acid-Base Disorders, Acidosis and Alkalosis, Acidosis/Alkalosis, aCL Syndrome, ACS, Acute DIC, Acute inflammatory demyelinating polyneuropathy, Acute Myocardial Infarct, Addison's Disease, Adrenal Insufficiency, Adrenal Insufficiency & Addison's Disease, Albuminuria, Alcohol dependence, Alcoholism, Allergies, Alzheimer's Disease, AMI, Anemia, Anencephaly, Angiitis, Angina, Angina pectoris, Ankylosing Spondylitis, Anthrax, Anticardiolipin Antibody Syndrome, Antiphospholipid Antibody Syndrome, Antiphospholipid Syndrome, aPL Syndrome, APLS, APS, Arteritis, Arthritis, AS, Asthma, Atypical Mycobacteria, Atypical Pneumonia, Autoimmune Disorders, Autoimmune thyroiditis, Avian flu, Bacillus anthracis infection, Benign Prostatic Hyperplasia, Benign Prostatic Hypertrophy, Biological Warfare, Bioterrorism Agents, Bleeding Disorders, Bone Marrow Disorders, BPH, Breast Cancer, Cardiovascular Disease, Celiac Disease, Celiac Sprue, Cervical Cancer, CFIDS, CFS, CHF, Chlamydia Chronic Fatigue and Immune Dysfunction Syndrome, Chronic Fatigue Syndrome, Chronic thyroiditis, Cobalamin, Colon Cancer, Colorectal Cancer, Community-Acquired Pneumonia, Congestive Heart Failure, Conn's Syndrome, Consumption, Consumption Coagulopathy, Copper storage disease, CREST, Cushing's Syndrome, Cutaneous anthrax, CVD, Cystic Fibrosis, Degenerative Joint Disease, Diabetes, Diabetes mellitus, Diarrhea, DIC, Diffuse Cutaneous Scleroderma, Diffuse thyrotoxic goiter, Disseminated Intravascular Coagulation, Disseminated Intravascular Coagulopathy, Disseminated lupus erythematosus, DJD, Double pneumonia, Down Syndrome, DS, Dysmetabolic Syndrome, Encephalitis, Endocrine Syndromes, Epilepsy, Excessive Clotting Disorders, Extraosseous plasmacytoma, Fibromyalgia, Folate Deficiency, Folic Acid, Fungal Infections, Gluten-Sensitive Enteropathy, Gonorrhea, Gout, Gouty arthritis, Graves Disease, Guillain-Barre Syndrome, H1N1, Hashimoto Thyroiditis, HD, Healthcare-Associated Pneumonia, Heart Attack, Heart Attack and Acute Coronary Syndrome, Heart Disease, Hemochromatosis, Hepatitis, Hepatolenticular degeneration, Herpes, Herpes Zoster, High blood pressure, HIV, HL, Hodgkin Lymphoma, Hodgkin's Disease, Hospital-Acquired Pneumonia, HPV, Hughes Syndrome, Human Immunodeficiency Virus, Huntington Disease, Huntington's Chorea Disease, Hypercoagulable Disorders or States, Hypersensitivity, Hypertension, Hyperthyroidism, Hypothyroidism, Infectious Arthritis, Infectious polyneuritis, Infertility, Inflammatory Bowel Disease, Influenza, Influenza A, Influenza B, Inhalation anthrax, Inherited copper toxicity, Insulin Resistance, Insulin Resistance Syndrome, jaundice, JCA, JIA, JRA, Juvenile chronic arthritis, Juvenile Idiopathic Arthritis, Juvenile Rheumatoid Arthritis, Keratoconjuntivitis sicca, Kidney and Urinary Tract Function, Kidney Disease, Landry's ascending paralysis, LE, Lead Poisoning, Leukemia, Limited Cutaneous Scleroderma, Linear Scleroderma, Liver Disease, Lobar pneumonia, Localized Scleroderma, Lower Respiratory Tract Infection, Lung Diseases, Lupus, Lupus Anticoagulant Syndrome, Lupus erythematosus, Lyme Disease, Lymphoma, Malabsorption, Malaria, Malnutrition, Meningitis and Encephalitis, Menopause, Metabolic Syndrome, MI, Morphea, Multiple Myeloma, Multiple Sclerosis, Mycobacteria other than tuberculosis, Myelocele, Myelomeningocele, Myeloproliferative Disorders, Myocardial Infarct, Neural Tube Defects, Neuropathy, non-Hodgkin lymphoma, Nontuberculous Mycobacteria, Obesity Syndrome, Osteoarthritis, Osteoarthrosis, Osteoporosis, Ovarian Cancer, Pancreatic Cancer, Pancreatic Diseases, Pancreatic Insufficiency, Pancreatitis, PCOS, Pelvic Inflammatory Disease, Peptic Ulcer, Pituitary Disorders, Plasma cell dyscrasia, Plasma cell myeloma, Plasma cell neoplasm, Plasmacytoma, Plasmacytoma of bone, Pneumonia, Polycystic Ovarian Syndrome, Post-infectious arthritis, Pregnancy, Primary hyperaldosteronism, Prostate Cancer, Protein in urine, Proteinuria, Reactive Arthritis, Reaven Syndrome, Rheumatoid Arthritis, Rheumatoid spondylitis, Sarcoidosis, Scleroderma, Sepsis, Septic Arthritis, Sexually Transmitted Diseases, Sexually transmitted infections, Shingles, Sicca syndrome, Sickle Cell Anemia, Sickle Cell Disease, Sjögren Syndrome, Spina bifida, Spinal dysraphism, Stable angina, Staph Wound Infections, Staph Wound Infections and Methicillin Resistant Staphylococcus aureus, Stein-Leventhal Syndrome, Stroke, Swine flu, Syndrome X, Syphilis, Systemic Lupus Erythematosus, Systemic Scleroderma, Systemic Sclerosis, Testicular Cancer, Thalassemia, Thrombophilia, Thyroid Diseases, Toxic diffuse goiter, Travelers Diseases, Trichomonas, Trisomy 21, Tuberculosis, Unstable angina, Urinary Tract Infection, Vasculitis, Venereal diseases, Vitamin B12 Deficiency, Vitamin B12 Deficiency and Folate Deficiency, Vitamin K Deficiency, Walking pneumonia, West Nile Virus, Wilson Disease, and Wound and Skin Infections.

Example health categories corresponding to family history include, but are not limited to: heart attack, coronary bypass surgery, Rheumatic or other heart disease, stroke, breast cancer, colon cancer, hip fracture, asthma, alzheimer's disease, high blood pressure, high blood cholesterol, and diabetes.

Example health categories corresponding to health interests include, but are not limited to any other health category described herein and/or various lifestyle categories (e.g., working out and meditation, among other examples).

Example health categories corresponding to genetics include, but are not limited to: disease risks and the various types thereof (e.g., Alzheimer's Disease, Psoriasis, Colorectal Cancer, Multiple Sclerosi, Primary Biliary Cirrhosis, Scleroderma (Limited Cutaneous Type), Esophageal Squamous Cell Carcinoma (ESCC), Stomach Cancer (Gastric Cardia Adenocarcinoma), Alopecia Areata, Bladder Cancer, Celiac Disease: Preliminary Research, Chronic Lymphocytic Leukemia, Glaucoma: Preliminary Research, Gout, Hodgkin Lymphoma, Keloid, Kidney Cancer, Paget's Disease of Bone, Primary Biliary Cirrhosis, Restless Legs Syndrome: Preliminary Research, Sarcoma, Cleft Lip and Cleft Palate, Developmental Dyslexia, Myeloproliferative Neoplasms, Sjögren's Syndrome, Breast Cancer, Venous Thromboembolism, Rheumatoid Arthritis, Restless Legs Syndrome, Age-related Macular Degeneration, Melanoma, Exfoliation Glaucoma, Ulcerative Colitis, Type 1 Diabetes, Celiac Disease, Crohn's Disease, Atrial Fibrillation: Preliminary Research, Bipolar Disorder: Preliminary Research, Breast Cancer Risk Modifiers, Dupuytren's Disease, Endometriosis, Gestational Diabetes, Hypothyroidism, Kidney Disease, Kidney Stones, Lou Gehrig's Disease (ALS), Nicotine Dependence, Osteoarthritis, Ovarian Cancer, Pancreatic cancer, Peripheral Arterial Disease, Polycystic Ovary Syndrome, Sarcoidosis, Melanoma: Preliminary Research, Thyroid Cancer, Uterine Fibroids, Back Pain, Creutzfeldt-Jakob Disease, Nonalcoholic Fatty Liver Disease, Obesity, Coronary Heart Disease, Diabetes, Atrial Fibrillation, Gallstones, Lung Cancer, Chronic Kidney Disease, Parkinson's Disease, Lupus (Systemic Lupus Erythematosus), Bipolar Disorder, Prostate Cancer, Abdominal Aortic Aneurysm, Ankylosing Spondylitis, Asthma, Atopic Dermatitis, Behçet's Disease. Brain Aneurysm, Chronic Obstructive Pulmonary Disease (COPD), Coronary Heart Disease, Follicular Lymphoma, Generalized Vitiligo, High Blood Pressure (Hypertension), Migraines, Progressive Supranuclear Palsy, Selective IgA Deficiency, Alcohol Dependence, Basal Cell Carcinoma, Cluster Headaches, Esophageal Cancer, Hay Fever (Allergic Rhinitis), Heart Rhythm Disorders (Arrhythmias), Larynx Cancer, Meningioma, Narcolepsy, Nasopharyngeal Carcinoma, Neuroblastoma, Oral and Throat Cancer, Otosclerosis, Parkinson's Disease, Schizophrenia, Scoliosis, Squamous Cell Carcinoma, Stomach Cancer, Stroke, Sudden Cardiac Arrest, Male Infertility, Testicular Cancer, Attention-Deficit Hyperactivity Disorder, Essential Tremor, Hashimoto's Thyroiditis, Hypertriglyceridemia, Neural Tube Defects, Placental Abruption, Preeclampsia, Tardive Dyskinesia, Intrahepatic Cholestasis of Pregnancy, Obsessive-Compulsive Disorder, and Tourette's Syndrome), carrier status (e.g., Alpha-1 Antitrypsin Deficiency, Agenesis of the Corpus Callosum with Peripheral Neuropathy (ACCPN), Autosomal Recessive Polycystic Kidney Disease, ARSACS, Bloom's Syndrome, BRCA Cancer Mutations, Canavan Disease, Congenital Disorder of Glycosylation Type 1a (PMM2-CDG), Cystic Fibrosis, D-Bifunctional Protein Deficiency, Dihydrolipoamide Dehydrogenase Deficiency, DPD Deficiency, Familial Dysautonomia, Factor XI Deficiency, Fanconi Anemia (FANCC-related), Familial Hypercholesterolemia Type B, Familial Hyperinsulinism (ABCC8-related), Familial Mediterranean Fever, G6PD Deficiency, Gaucher Disease, GRACILE Syndrome, Glycogen Storage Disease Type 1a, Glycogen Storage Disease Type 1b, Hemochromatosis, Primary Hyperoxaluria Type 2 (PH2), Hypertrophic Cardiomyopathy (MYBPC3 25 bp-deletion), LAMB3-related Junctional Epidermolysis Bullosa, Limb-girdle Muscular Dystrophy, Medium-Chain Acyl-CoA Dehydrogenase (MCAD) Deficiency, Maple Syrup Urine Disease Type 1B, Mucolipidosis IV, Neuronal Ceroid Lipofuscinosis (CLN5-related), Neuronal Ceroid Lipofuscinosis (PPT1-related), Niemann-Pick Disease Type A, Nijmegen Breakage Syndrome, Connexin 26-Related Sensorineural Hearing Loss, Pendred Syndrome, Phenylketonuria, Rhizomelic Chondrodysplasia Punctata Type 1 (RCDP1), Salla Disease, Sickle Cell Anemia & Malaria Resistance, Tay-Sachs Disease, Torsion Dystonia, and Zellweger Syndrome Spectrum), drug response (e.g., Abacavir Hypersensitivity, Clopidogrel (Plavix®) Efficacy, Fluorouracil Toxicity, Response to Hepatitis C Treatment, Pseudocholinesterase Deficiency, Warfarin (Coumadin®) Sensitivity, Caffeine Metabolism, Hepatitis C Treatment Side Effects, Metformin Response, Antidepressant Response, Beta-Blocker Response, Floxacillin Toxicity, Heroin Addiction, Lumiracoxib (Prexige®) Side Effects, Naltrexone Treatment Response, Postoperative Nausea and Vomiting (PONV), Response to Interferon Beta Therapy, and Statin Response), and traits (e.g., memory, response to exercise, etc.).

It should be understood that the various health categories described herein are provided for purposes of example and explanation only. Other examples of such health categories may exist, and the examples set forth herein should not be taken to be limiting.

Health category metrics corresponding to each category may be, or may be determined based on, commonly used referenced ranges, known medical decision tree algorithms, or custom made algorithms (e.g. generated via a Populational feedback loop of longitudinal patient data based on outcomes). A given health category metric may provide, for example, an indication of diagnostic status, disease progression, risk assessment, or a pharmacological response activity of a drug, among other examples. For example, labs related to cardiovascular disease (total cholesterol, ldl, hdl, triglycerides, Apolipoprotein B, urinary microalbumin, and myloperoxidase) may be categorized and a corresponding health category metric may be determined. In such a case, a qualitative risk-assessment health category metric of developing cardiovascular disease (e.g. High-risk) may be determined, Additionally, sub-metric(s) may also be determined for each category to further stratify the patient (e.g. near-term risk of have a cardiac event).

Notably, the one or more health-category metrics may be, or may be determined based on, a qualitative- or quantitative-based reference-range value. Alternatively, the one or more health-category metrics may be determined from a multiple test-driven medical algorithm decision tree value. Correspondingly, determining the set of health categories may involve sorting the laboratory test data based on a medical algorithm decision tree. Other examples of health-category metrics may exist.

In an implementation, server 106 may also determine, based on the set of health categories, at least one health goal.

Determination of the at least one health goal may be performed after determination of the health categories and the corresponding health category metrics. The health goal may take the form of possible and/or medically validated treatment choices (e.g. pharmaceutical drugs, diet recommendations, life style, and supplements and vitamins, among other examples) from a medical treatment database. In the case of a health category involving type-2-diabetes, for example, the system may determine various health goals and/or associated therapies to choose from which might include lifestyle options (e.g. light exercise and walking daily), dietary recommendations (e.g. plant-based diet or diabetes supportive meals/recipes), pharmaceutical drugs (metformin and Januvia), and/or supplements or vitamins (e.g. chromium). In an implementation, the system may present multiple health goals to the user (e.g. patient), and the user may be able to select a particular therapy. Other examples may exist as well.

Determination of the health goal may be performed by one or more of various modules included in data analysis module 154. For instance, risk rules module 184 may include various rules used to determine whether a patient is at risk for a given medical condition. Diagnoses rules module 186 may include various rules used to diagnose a given health goal. And health/fitness rules module 188 may include various rules used to identify health/fitness goals and/or plans. Other examples may exist.

FIG. 5B shows another example user interface 520 in accordance with method 400. Example user interface 520 depicts details corresponding to a particular improve cholesterol health goal 522 selected by a patient. Accordingly, the indicated health goal 522 includes a particular health goal of improving cholesterol. Other examples of such health goals exist.

As shown progress indicator 524 provides an indication of the patient's progress as it pertains to health goal 522. In this particular example, the progress indicator indicates that, as of the patient's last testing, the patient had a cholesterol level that fell within a “high risk” range of 90 mg/dl to 200 mg/dl. Moreover, the progress indicator also indicates that this cholesterol level fell outside of a “target” range of 0 mg/dl to 90 mg/dl.

Progress indicator 524 also provides an indication that 34 days have passed since the goal was set on Jul. 15, 2014. Progress indicator 524 also indicates a health goal completion date of Jan. 15, 2015, which means 150 days are remaining until the completion date. Accordingly, the indicated health goal 522 includes a particular goal completion date.

As shown, example user interface 520 also includes a supporting connections indication 526, which indicates devices and/or applications that the user may use to help pursue health goal 526. In this particular example, supporting connections indication 526 includes an indication of a FitBit® device and a Calorie Count application. Such devices and/or applications are discussed further below.

Finally, user interface 520 also includes a suggested goals indicator 528. Suggested goals indicator 528 may include one or more additional and/or alternative health goals that the patient may opt for has opted) to pursue. In this particular example, suggested goals indicator 528 includes an indication of an “Improve Fasting Glucose” health goal.

b. Detect One or More of (a) at Least One Device or (b) at Least One Application

At block 404, server 106 selects one or more of at least one device or at least one application based on the detected identification of the at least one theory.

In accordance with block 404, the at least one device may be any device related to an identified health goal. Such a device may in some way possibly aid the patient in pursuing the health goal and/or track the patient's progress in pursing the health goal, and/or therapy associated with a given goal. Further, in accordance with block 404, the at least one application may be any application related to an identified theory. Such an application may in some way possibly aid the patient in pursuing the health goal and/or track the patient's progress in pursing the health goal. Examples of such devices and/or applications include, but are not limited to, Bodymedia Armband Advantage, Bodymedia Core, BodyMedia FIT App and Webportal, Bodymedia Link, Dailymile, Calorie Counter by Fat Secret, Fitbit Aria Scale, Fitbit App and Webportal, Fitbit Flex, Fitbit Force, Fitbit One, Fitbit Ultra, Fitbit Zip, Fitbug Air, Fitbug Go, Fitbug Orb, Fitbug WoW Wireless Scale, Fleetly, Garmin Edge 200, Garmin Edge 205, Garmin Edge 305, Garmin Edge 510/500, Garmin Edge 605, Garmin Edge 705, Garmin Edge 810/800, Garmin Fenix, Garmin Fit App, Garmin Connect App, Garmin Forerunner 10, Garmin Forerunner 101, Garmin Forerunner 201, Gamin Forerunner 220, Garmin Forerunner 210, Garmin Forerunner 301, Garmin Forerunner 305, Garmin Forerunner 310XT, Garmin Forerunner 405, Garmin Forerunner 410, Garmin Forerunner 50, Garmin Forerunner 610, Garmin Forerunner 620, Garmin Forerunner 910XT, Garmin FR60, Garmin FR70, Garmin Vivofit, Garmin Swim, iHealth Wireless Smart Gluco Monitoring System, iHealth Blood Pressure Dock, iHealth Wireless Activity and Sleep Tracker, iHealth Wireless Blood Pressure Monitor, iHealth Wireless Blood Pressure Wrist Monitor, iHealth Wireless Body Analysis Scale, iHealth Wireless Pulse Oximeter, iHealth Wireless Scale, Jawbone UP24, Jawbone UP, Jawbone UP App and Webportal, LF Connect, Life Fitness Elevation Discover SE and SI Treadmill, Life Fitness Elevation Discover SE and SI Cross-Trainer, Life Fitness Elevation Discover SE and SI Upright Bike, Life Fitness Elevation Discover SE and SI Recumbent Bike, Life Fitness Elevation Discover SE and SI FlexStrider, Life Fitness Elevation Discover SE and SI PowerMill, Life Fitness Platinum Club Discover SE and SI Treadmill, Life Fitness Platinum Club Discover SE and SI Cross-Trainer, Life Fitness Platinum Club Discover SE and SI Upright Bike, Life Fitness Platinum Club Discover SE and Recumbent Bike, Life Fitness Track+ Treadmills, Life Fitness Track+ Cross-Trainers, Life Fitness Track+ Upright Bikes, Life Fitness Track+ Recumbent Bikes, ManageBGL Blood Glucose Monitor App, MapMyFitness, MapMyHike, MapMyRide, MapMyRun, MapMyWalk, Misfit Shine, Movable MOVband, Moves App, Nike+ FuelBand, Nike+ Running, Omron Fitness Activity Monitor (HJA-312), Omron Fitness USB Pedometer (HJ-323U), Omron Fitness USB Pedometer (HJ-324U), RunKeeper, Strava Cycling, Strava Running, Sync Burn Fitness Band, Sync Calorie Activity Tracker, Sync Distance Activity Tracker, Sync Elite Activity Tracker, Sync Fit Fitness Band, Sync GPS+HR Watch (M/W), Sync GPS Watch (M/W), Sync Heartrate Soft Strap, Sync Steps Activity Tracker, Telcare Wireless Blood Glucose Meter, Medisana CardioDock, Medisana GlucoDock, Medisana TargetScale, Medisana ViFit Activity Tracker, Medisana VitaDock, Withings Blood Pressure Monitor, Withings Healthmate Activity Tracker, Withings Pulse Activity Tracker, Withings Smart Body Analyzer Scale, and Withings WS-30 Wireless Scale. Many more examples exist.

Accordingly, the at least one device may be hardware implementing a pedometer, a cycling monitor, a GPS device, a blood glucose monitor, a scale, an activity tracker, and a calorie counter. Other examples exist.

Similarly, the at least one application may be software implementing a pedometer, a cycling monitor, a GPS device, a blood glucose monitor, a scale, an activity tracker, and a calorie counter. Other examples exist.

The device and/or application may be selected in any suitable manner. In one implementation, server 106 may maintain a database that associates the device and/or application with certain respective health goals. For instance, server 106 may store a look up table that indicates associations between health goals and devices and/or applications. Upon identifying a given health goal, server 106 may then select a device and/or application corresponding to the identified health goal

In some implementations, selecting the set of the devices and applications comprises selecting devices and applications corresponding to a risk factor corresponding to the detected identification of the at least one health goal. For instance, server 106 may select a device and/or application for a given health goal that corresponds to a health category for which a patient has a risk factor that is out of range. Additionally and/or alternatively, the device and/or application may be selected depending on the magnitude of the risk factor. For instance, a first given device and/or application may be selected when a risk factor is relatively slightly out of range, and a second given device and/or application may be selected when a risk factor is relatively greatly out of range.

In some implementations, selecting the device and/or application may involve identifying a set of devices and applications corresponding to at least one goal type. For instance, the identified health goal may correspond to a given goal type. Then, the selected device and/or application may correspond to the goal of the goal type. Accordingly, server 106 may maintain a database that associates the device and/or application with certain respective goals and/or goal types. For instance, server 106 may store a look up table that indicates associations between goals, goal types, devices, and/or applications. Upon identifying a given health goal, server 106 may then select a device and/or application corresponding to a goal type associated with the given health goal.

In some instances selecting the one or more of the at least one device or the at least one application in accordance with block 404 may involve selecting both of the at least one device and the at least one application. For instance, it may be the case that both a device and an application are related to a given health goal.

In some instances, selecting the one or more of the at least one device or the at least one application may involve identifying a set of devices and applications corresponding to the detected identification of the at least one health goal. To help illustrate, FIG. 5C shows another example user interface 530 in accordance with method 400. User interface 530 shows various identified devices and applications. For instance, user interface 530 shows a set of devices and/or applications corresponding to therapy grouping “activity” 532 that include FitBit, Gamin, Moves, and Nike+. User interface 530 also shows a set of devices and/or applications corresponding to therapy grouping “nutrition” 534 that include Calorie Count and Sync. User interface 530 also shows a set of devices and/or applications corresponding to health-goal type “weight” 536 that includes FitBit, Withings, VitaDock, and iHealth. User interface 530 also shows a set of devices and/or applications corresponding to therapy grouping “biometrics” 538 that include iHealth, VitaDock, and Withings.

Thus, as shown, multiple sets of devices and applications may be identified. Moreover, certain devices and/or applications may appear in multiple sets of identified devices and applications.

Further a target date 539 may be displayed and/or selected by a patient.

Before selecting the one or more of the at least one device or the at least one application, server 106 may receive an indication of a registration of the selected one or more at least one device or at least one application. For instance, a patient may provide an indication via a user input that the patient has available for use one or more devices and/or applications.

To help illustrate, FIG. 5D shows another example user interface 540 in accordance with method 400. User interface 540 includes connections indicator 542, which includes an indication of a number of devices and/or applications that a patient has previously added as connections (i.e., registered). As shown, the user may select the “add a connection” button to register additional such devices and/or applications to the system.

Accordingly, FIG. 5E shows another example user interface 550 in accordance with method 400. User interface 550 generally facilitates the registration of devices and/or applications by a patient. User interface 550 may be presented to a patient after the patient selections the “add a connection” button as shown in user interface 540. As shown, user interface 550 includes “add connection” indicator 552. Add connection indicator 552 depicts a number of devices and applications that may be selected by the patient for registration. Upon selection of any such device and/or application, the selected device and/or application may registered for use, and/or a registration process may be initiated.

FIG. 5F shows another example user interface 560 in accordance with method 400. User interface 560, like user interface 550, generally facilitates the registration of devices and/or applications by a patient. Add connection indicator 562 depicts a number of devices and applications that may be selected by the patient for registration.

FIG. 5G shows another example user interface 570 in accordance with method 400. As shown, user interface 570 shows various example aspects and/or features of examples described above.

c. Cause Graphical Display to Display Indication of Selected One or More of (a) at Least One Device or (b) at Least One Application

At block 406, server 106 causes, via user interface 220 of network-access device 102A (perhaps by way of public network 104), a graphical display to display an indication of the selected one or more of (i) at least one device or (ii) at least one application. Such a display may be provided as described above with respect to any user interface shown in FIGS. 5A-5G. As one particular example, FIG. 5B shows devices and/or applications 526 corresponding to improve cholesterol goal 521. Other examples exist.

d. Additional Functions

Server 106 may be configured to carry out various functions in addition to those functions described with respect to FIG. 4.

i. Purchase Functionality

Further, server 106 may be configured to, after causing the graphical display to display the indication of the selected one or more of (a) at least one device or (b) at least one application, receive, purchase data indicating a purchase of the selected one or more of (a) at least one device or (b) at least one application. Accordingly, server 106 may be configured to prompt the user, using suitable visual indications displayed via graphical display 224, to input, via input device 222, an indication that the user desires to purchase any suitable device and/or application. Network-access node 102A may be configured to transmit to server 106 purchase data that indicates the user's desire to purchase a given device and/or application.

Further, server 106 may be configured to, after receiving the purchase data, transmit the received purchase data to a distributor. Generally, the purchase data may include information sufficient to enable the distributor to identify the purchased device and/or application. In this way, a request for a given device and/or application may be submitted to the distributor upon receipt of the user's purchase.

### 3. SECOND EXAMPLE METHOD

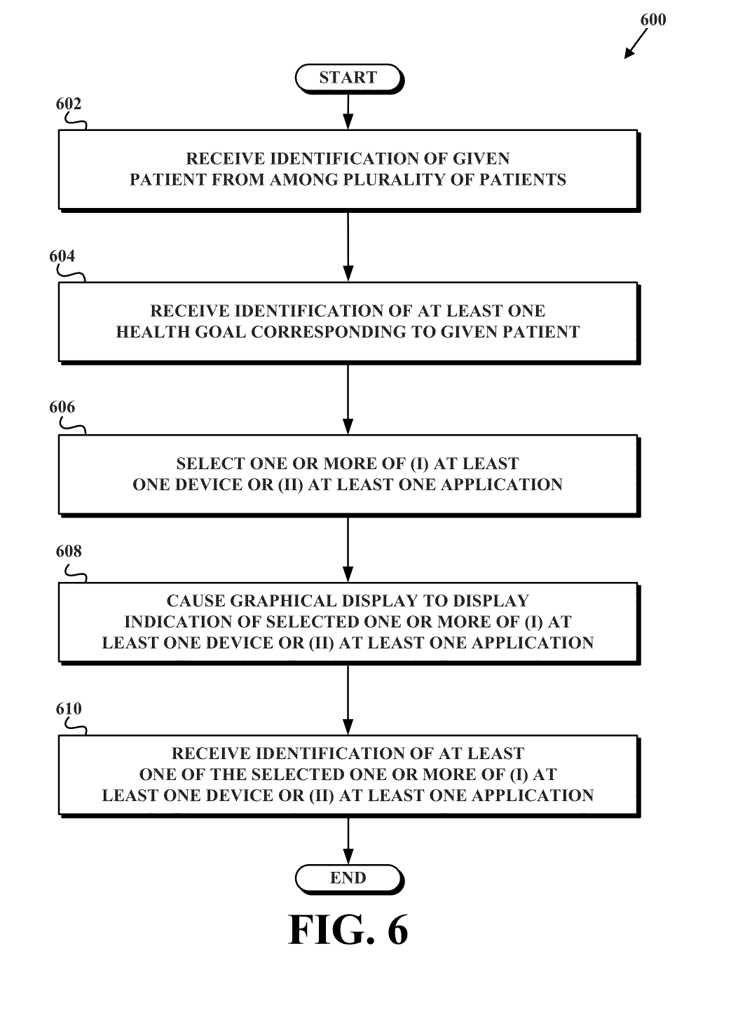

FIG. 6 shows a flowchart depicting an example method for dynamically selecting and displaying devices and/or applications. Method 600 is described, by way of example, as being carried out by a computing system such as, for example, server 106. However, it should be understood that example methods disclosed herein, such as method 400, may be carried out by computing systems other than a server, and/or may be carried out by sub-systems in a server or in other devices. For example, the example method may alternatively be carried out entirely by a network-access device or some other computing system that may or may not be coupled to any network. Other examples are also possible.

Furthermore, those skilled in the art will understand that the flowchart described herein with respect to FIG. 6 illustrates functionality and operation of certain implementations of example embodiments. In this regard, each block of the flowchart may represent a module, a segment, or a portion of program code, which includes one or more instructions executable by a processor (e.g., processor 302 described below with respect to server 106) for implementing specific logical functions or steps in the process. The program code may be stored on any type of computer readable medium (e.g., computer readable storage medium or non-transitory media, such as data storage 304 described above with respect to server 106), for example, such as a storage device including a disk or hard drive. In addition, each block may represent circuitry that is wired to perform the specific logical functions in the process. Alternative implementations are included within the scope of the example embodiments of the present application in which functions may be executed out of order from that shown or discussed, including substantially concurrent or in reverse order, depending on the functionality involved, as would be understood by those reasonably skilled in the art.

FIG. 6 shows a flowchart depicting functions that can be carried out in accordance with at least one embodiment of the method. As shown in FIG. 6 method 600 begins at block 602 with server 106 receiving an identification of a given patient from among a plurality of patients. At block 604, server 106 receives an identification of at least one health goal corresponding to the given patient. At block 606, server 106 selects one or more of (i) at least one device or (ii) at least one application based on the received identification of the at least one health goal. At block 608, server 106 causes a graphical display to display an indication of the selected one or more of (i) at least one device or (ii) at least one application. At block 610, server 106 detects an identification of at least one of the selected one or more of (i) at least one device or (ii) at least one application. These steps are explained further in the following subsections.

a. Receive Identification of Patient

At block 702, server 106 receives (perhaps by way of public network 104) an identification of a given patient from among a plurality of patients. The identification of the given patient may be received by server 106 from a network access device, perhaps as a result of user input at the network access device.

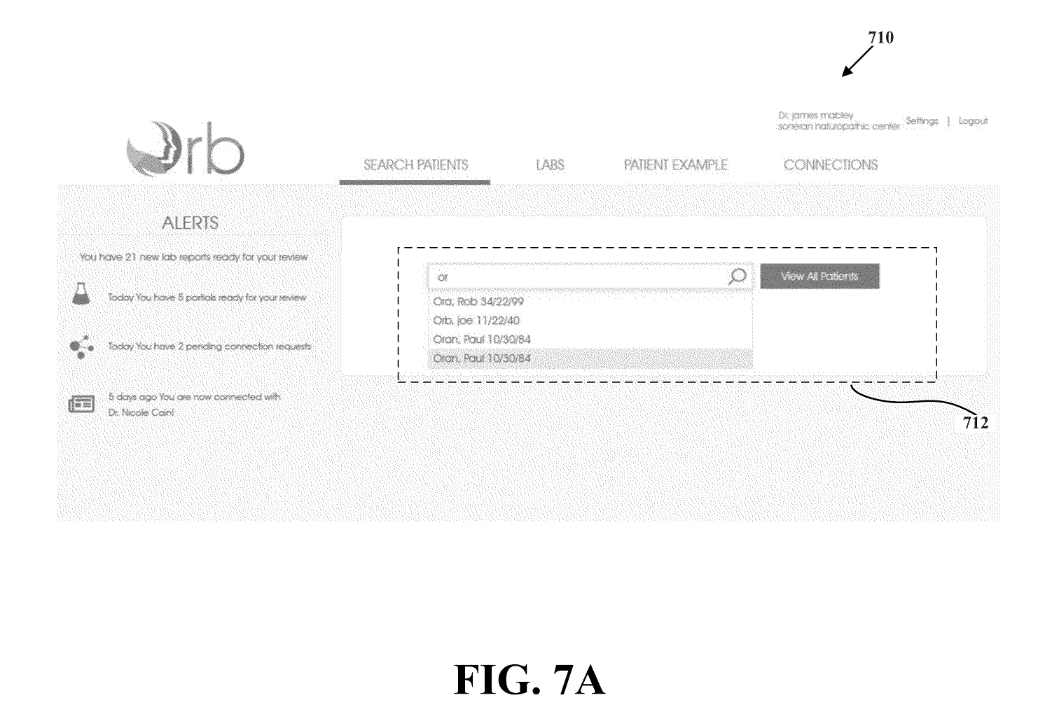

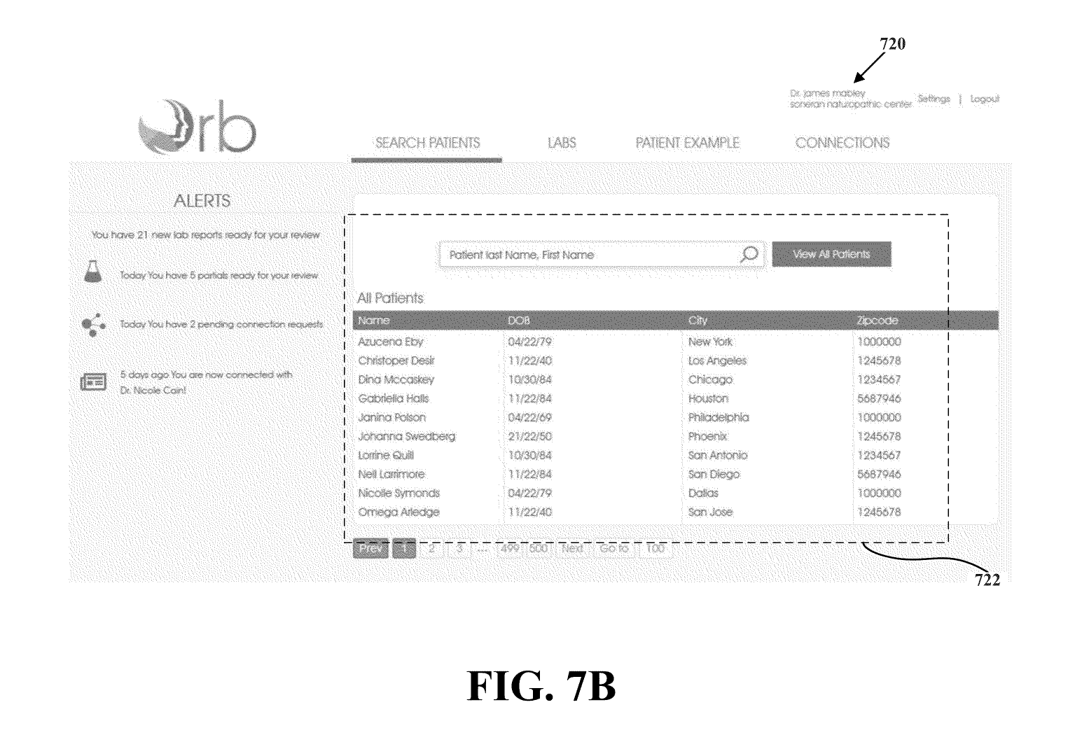

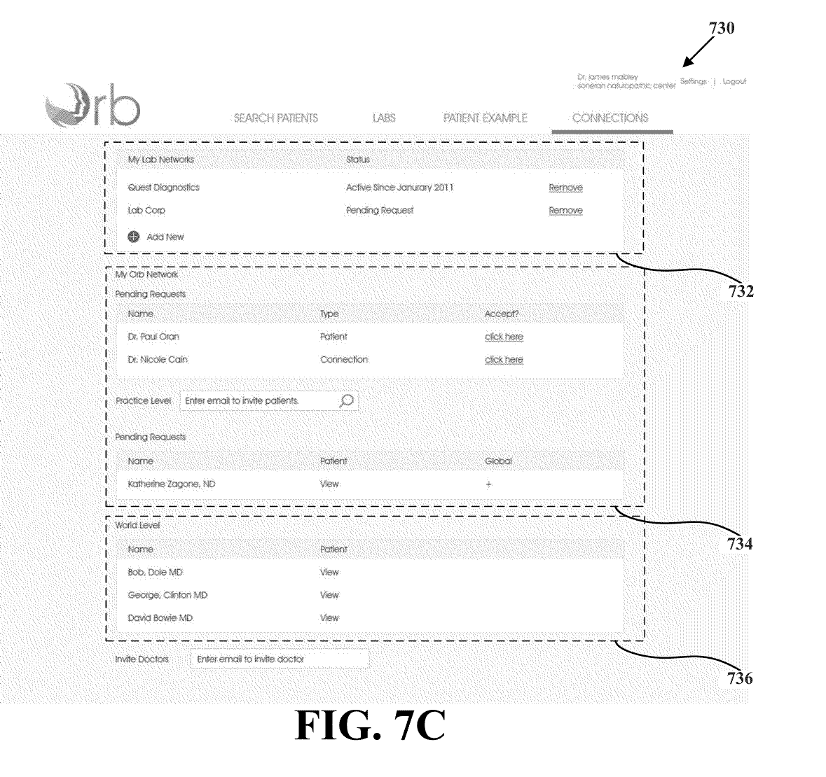

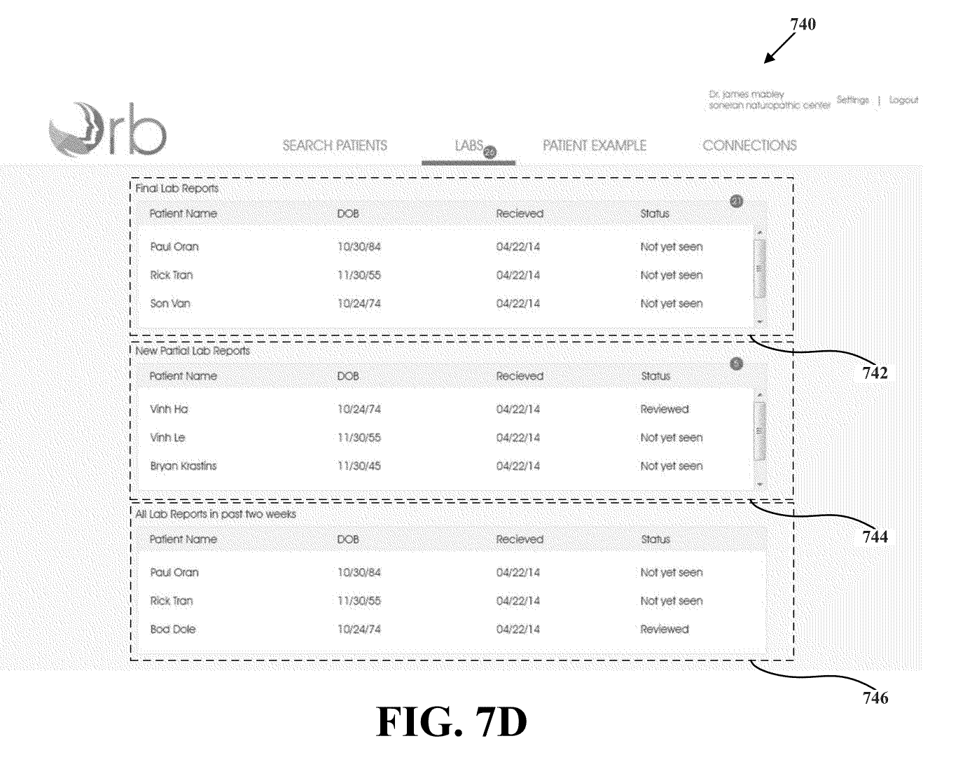

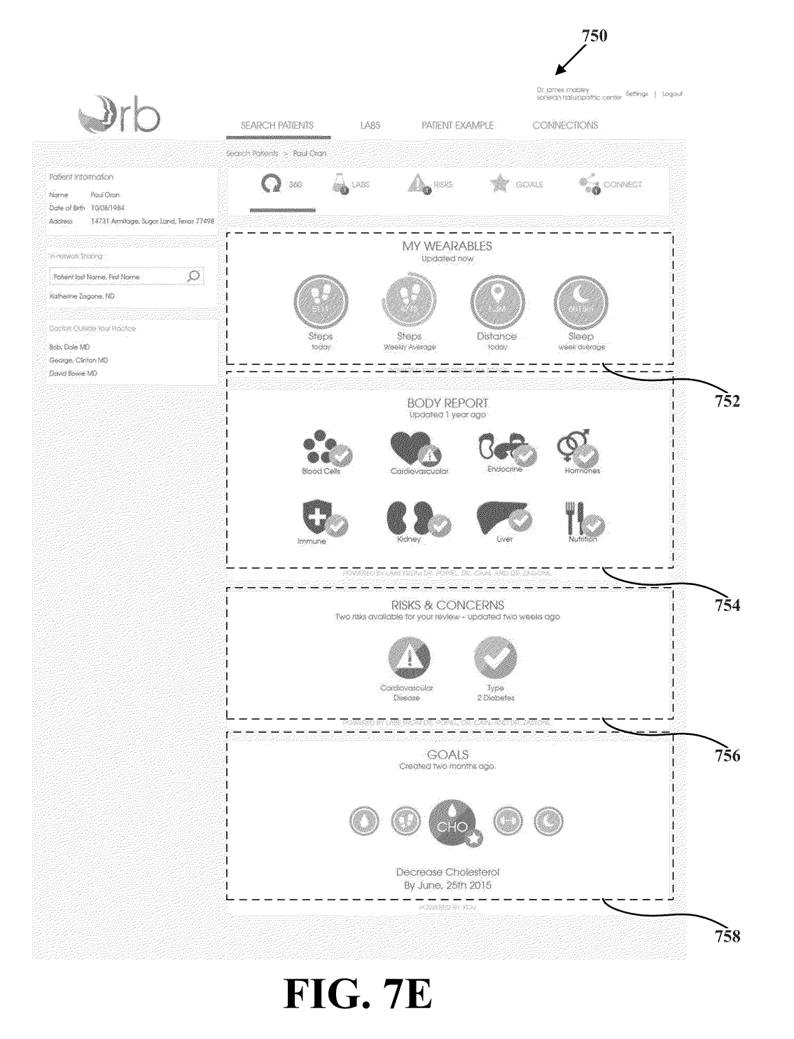

In one implementation, the identification of the given patient may be provided by doctor input via a GUI at a network access device. As one example, FIG. 7A shows an example user interface 710 in accordance with method 600. FIG. 7A shows an example display of a plurality of patients, where the plurality of patients corresponds to a given search term. Any one of such plurality of patients 712 may be selected in accordance with block 702, and thereby received by server 106.

As another example, FIG. 7B shows another example user interface 720 in accordance with method 600. FIG. 7B shows an example display of a plurality of patients, where the plurality of patents corresponds to all patients in a given record set. Any of such plurality of patients 722 may be selecting in accordance with block 702, and thereby received by server 106.

b. Receive Identification of Health Goal

At block 604, server 106 receives (perhaps by way of network 104) an identification of at least one health goal corresponding to the given patient.

The identification of the at least one health goal may correspond to a doctor-identified health goal. For instance, in accordance with block 604, a doctor may provide an input that identifies the at least one health goal. In one case, such an input may be provided in response a prompt to select, from among a plurality of health goals, a particular health goal. As a result of the input, the identified health goal may be provided to server 106. Accordingly, a health professional (e.g. doctor) can select goals and associated therapies for their respective patient(s). After approving a goal and/or specific therapy, and/or therapy grouping, for the patient(s), the individual patient/user can activate devices and applications they use or want to begin using to comply with the doctor recommended goals and associated therapies.

Alternatively and/or additionally, the identification of the at least one health goal may correspond to a patient-identified health goal. For instance, in accordance with block 604, a patient may provide an input that identifies the at least one health goal. In one case, such an input may be provided in response a prompt to select, from among a plurality of health goals, a particular health goal. As a result of the input, the identified health goal may be provided to server 106.

Alternatively and/or additionally, the identification of the at least one health goal may correspond to a health goal identified by server 106 itself and/or some other such computing system. Such identification of a health goal may be performed, for instance, in accordance with functions described above with respect to block 402 relating to the selection of health goals.

c. Select at Least One Device or at Least One Application

At block 606, server 106 selects one or more of (i) at least one device or (ii) at least one application based on the received identification of the at least one health goal. Such selection of at least one device or at least one application may be performed, for instance, in accordance with functions described above with respect to block 404.

d. Cause Display of Selected at Least One Device or at Least One Application

At block 608, server 106 causes a graphical display to display an indication of the selected one or more of (i) at least one device or (ii) at least one application. Such display of the selected at least one device or at least one application may be performed, for instance, in accordance with function described above with respect to block 406.

e. Receive Identification of at Least One Device or at Least One Application

At block 610, server 106 receives an identification of at least one of the selected one or more of (i) at least one device or (ii) at least one application. In accordance with block 610, a doctor may identify a particular one or more device and/or application to recommend, prescribe, or otherwise instruct a patient to use.

f. Additional Functions

Server 106 may be configured to carry out various functions in addition to those functions described with respect to FIG. 600.

i. Reports Browse

FIG. 7D shows another example user interface 740. As shown in FIG. 7D, server 106 may provide various views that enable a doctor to browse lab reports associated with the doctor's patients and/or associated with other patients that the doctor is associated with.

For example, as shown by final lab reports view 742, a doctor may observe final lab reports associated with the doctor's patients. As shown by partial lab reports view 744, a doctor may observe partial lab reports associated with the doctor's patients. As shown by all lab reports in the last two weeks view 746, a doctor may additionally and/or alternatively review all lab reports received in the last two weeks. Such a view may be tailored to any desired time frame.

ii. Patient Information Review

FIG. 7E shows another example user interface 750. As shown in FIG. 7E, server 106 may provide various views that enable a doctor to observe information associated with a given patient. For instance, as shown by my wearables view 752, a doctor may observe various information obtained by wearable devices a patient is utilizing. As shown by body report view 754, a doctor may observe an indication of the status of various health categories associated with a patient. As shown in risks and concerns view 756, a doctor may observe particular health categories for which the patient has an associated risk and/or concern. As shown in goals view 758, a doctor may observe certain health goals and/or goals that the patient is currently pursuing and/or that are recommended that the patient should pursue.

### 4. CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. A method comprising:
detecting, by a computing system, an identification of at least one health goal;
selecting, by the computing system, one or more of (i) at least one device or (ii) at least one application based on the detected identification of the at least one health goal; and
causing, by the computing system, a graphical display to display an indication of the selected one or more of (i) at least one device or (ii) at least one application.

2. The method of claim 1, further comprising:
before detecting the identification of the at least one health goal, causing, by the computing system, the graphical display to display an indication of a plurality of health goals, wherein the plurality of health goals comprises the at least one health goal.

3. The method of claim 2, further comprising:
maintaining, by the computing system, health data; and
before causing the graphical display to display the indication of the plurality of health goals, determining the plurality of health goals based on the maintained health data.

4. The method of claim 3, wherein determining the plurality of health goals based on the maintained health data comprises determining at least one health goal in the plurality of health goals based on an identification that a risk factor is out of range.

5. The method of claim 3, wherein maintaining the health data comprises receiving, by the computing system, the health data via at least one of (i) a network interface or (ii) a user interface.

6. The method of claim 5, wherein the health data is received via the network interface, over a Wide Area Network (WAN), from another computing system associated with a health service provider.

7. The method of claim 5, wherein the health data is received via a the user interface, wherein receiving the health data via the user interface comprises detecting a touch input.

8. The method of claim 5, wherein maintaining the health data comprises receiving, by the computing system, the health data via both (i) the network interface and (2) the user interface.

9. The method of claim 1, wherein selecting the one or more of (a) the at least one device or (b) the at least one application, comprises selecting both of (a) the at least one device and (b) the at least one application.

10. The method of claim 1, wherein selecting the one or more of (a) the at least one device or (b) the at least one application comprising identifying a set of devices and applications corresponding to the detected identification of the at least One health goal.

11. The method of claim 10, wherein selecting the set of the devices and applications comprises selecting devices and applications corresponding to a risk factor corresponding to the detected identification of the at least one health goal.

12. The method of claim 10, wherein the at least one health goal is associated with at least one therapy grouping, and wherein selecting the one or more of (a) the at least one device or (b) the at least one application further comprises identifying a set of devices and applications corresponding to the at least one therapy grouping.

13. The method of claim 12, wherein the at least one therapy grouping is one of activity, vitals, nutrition, or cardiovascular health.

14. The method of claim 1, wherein the at least one device is one of a pedometer, a cycling monitor, a GPS device, a blood glucose monitor, a scale an activity tracker, or a calorie counter.

15. The method of claim 1, wherein the at least one application is one of a pedometer, a cycling monitor, a GPS device, a blood glucose monitor, a scale an activity tracker, or a calorie counter.

16. The method of claim 1, wherein the at least one health goal comprises a goal completion data and a health result.

17. The method of claim 1, further comprising:
before selecting the one or more of (a) the at least one device or (b) the at least one application, receiving, by the computing system, an indication of a registration of the selected one or more (a) at least one device or (b) at least one application.

18. The method of claim 1, further comprising:
after causing the graphical display to display the indication of the selected one or more of (a) at least one device or (b) at least one application, receiving, by the computing system, purchase data indicating a purchase of the selected one or more of (a) at least one device or (b) at least one application.

19. A non-transitory computer readable medium having instructions stored thereon, the instructions comprising:
instructions for detecting, by a computing system, an identification of at least one health goal;
instructions for selecting, by the computing system, one or more of (i) at least one device or (ii) at least one application based on the detected identification of the at least one health goal; and
instructions for causing, by the computing system, the graphical display to display an indication of the selected one or more of (i) at least one device or (ii) at least one application.

20. A method comprising:
receiving, by a computing system, an identification of a given patient from among a plurality of patients;
receiving, by the computing system, an identification of at least one health goal corresponding to the given patient;
selecting, by the computing system, one or more of (i) at least one device or (ii) at least one application based on the received identification of the at least one health goal;
causing, by the computing system, a graphical display to display an indication of the selected one or more of (i) at least one device or (ii) at least one application; and
receiving, by the computing system, an identification of at least one of the selected one or more of (i) at least one device or (ii) at least one application.
